(19) United States
(12) Patent Application Publication
(10) Pub. No.: US 2026/0119098 A1
(43) Pub. Date: Apr. 30, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: MASAKI KAWANISHI, Kanagawa (JP)

(21) Appl. No.: 19/364,342

(22) Filed: Oct. 21, 2025

(30) Foreign Application Priority Data
Oct. 25, 2024 (JP) 2024-188439

(51) Int. Cl. G06F 3/12

(52) U.S. Cl. CPC G06F 3/1259; G06F 3/1203; G06F 3/1285

(57) ABSTRACT

An information processing apparatus of the present disclosure is an information processing apparatus capable of performing a remote operation of an image forming apparatus, and includes a notification unit configured to give notification of notification information on a progress status of remote connection. The notification information is determined based on first information indicating a state of the remote operation between the information processing apparatus and the image forming apparatus and second information indicating a use status of the image forming apparatus.

### BACKGROUND

### Field of the Technology

The present disclosure relates to an information processing apparatus, an information processing method, and a storage medium.

### Description of the Related Art

There is a function referred to as a remote operation in which an operation panel of an image forming apparatus such as a printer is operated from an information processing apparatus at a remote location. This is achieved by using, for example, software referred to as virtual network computing (VNC). The VNC includes server software and client software. The VNC server software is launched on the server side, and the client launches the VNC client software to remotely operate the server. A remote framebuffer (RFB) protocol (RFC 6143) is used for communication between the server and the client of the VNC. Launching the VNC server software in the image forming apparatus allows the information processing apparatus such as a PC or a mobile terminal to remotely operate the image forming apparatus by using the VNC client software.

Moreover, the information processing apparatus can also remotely operate the image forming apparatus by connecting to the image forming apparatus while using a web browser included in the information processing apparatus, and by connecting to the VNC server of the image forming apparatus via the web browser.

Japanese Patent Laid-Open No. 2022-073282 (Patent Literature 1) is disclosed in regard to the remote operation of the image forming apparatus. Patent Literature 1 describes a technique in which, in the case where the image forming apparatus receives a disconnection request of remote connection in a state where a remote user using the image forming apparatus by the remote operation is logged in the image forming apparatus, the image forming apparatus automatically executes a logout process of this remote user.

### SUMMARY

There is demand for further improving operability in the remote operation of the image forming apparatus.

Embodiments of the present disclosure provide an information processing apparatus capable of performing a remote operation of an image forming apparatus, and includes a notification unit configured to give notification of notification information on a progress status of remote connection. The notification information is determined based on first information indicating a state of the remote operation between the information processing apparatus and the image forming apparatus and second information indicating a use status of the image forming apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a system configuration of an information processing system of the present disclosure.

FIG. 2 is a hardware configuration diagram of an image forming apparatus.

FIG. 3 is a software configuration diagram of the image forming apparatus.

FIG. 4 is a hardware configuration diagram of a PC.

FIG. 5 is a software configuration diagram of the PC.

FIG. 6 is a diagram illustrating a functional configuration of the information processing system.

FIG. 7 is a diagram illustrating an example of notification information (messages).

FIG. 8 is a diagram illustrating an example of a setting value of a remote operation setting.

FIG. 9 is a diagram illustrating an example of a remote operation setting screen.

FIG. 10 is a flowchart explaining a display process of a remote UI screen.

FIG. 11 is a diagram illustrating an example of a top page of the remote UI screen.

FIG. 12 is a flowchart explaining a display process of a remote operation screen.

FIG. 13 is a diagram illustrating an example of the remote operation screen before start of the remote operation.

FIG. 14 is a diagram illustrating another example of the remote operation screen before start of the remote operation.

FIG. 15 is a diagram showing the relationship of FIGS. 15A and 15B.

FIGS. 15A and 15B are totally a flowchart explaining a start process of the remote operation.

FIG. 16 is a diagram illustrating an example of the remote operation screen during preparation for execution of the remote operation.

FIG. 17 is a diagram illustrating another example of the remote operation screen during preparation for execution of the remote operation.

FIG. 18 is a diagram illustrating an example of a confirmation screen for permitting or denying the remote operation.

FIG. 19 is a diagram illustrating an example of the remote operation screen during execution of the remote operation.

FIG. 20 is a diagram illustrating another example of the remote operation screen during execution of the remote operation.

FIG. 21 is a diagram illustrating an example of the remote operation screen that gives notification of a connection denial error.

FIG. 22 is a flowchart explaining a login process to the image forming apparatus.

FIG. 23 is a diagram illustrating an example of a login screen.

FIG. 24 is an example of a home screen displayed in an operation unit of the image forming apparatus.

FIG. 25 is a flowchart explaining a logout process of the image forming apparatus.

FIG. 26 is a flowchart explaining a termination process of the remote operation.

FIG. 27 is a diagram illustrating an example of a top page of a remote UI screen in a modified example.

FIG. 28 is a diagram illustrating an example of the remote operation screen during execution of the remote operation in the modified example.

FIG. 29 is a diagram illustrating a functional configuration of an information processing system according to a second embodiment.

### DESCRIPTION OF THE EMBODIMENTS

Embodiments of the present disclosure are explained below by using the drawings. In a conventional technique, there is a possibility that a user (remote user) of an information processing apparatus who is a user to use an image forming apparatus through a remote operation stands by for establishment of remote connection between the image forming apparatus and the information processing apparatus in a state where the user cannot recognize a time period required for the establishment of the remote connection. Accordingly, in the present disclosure, a use status of the image forming apparatus by a user other than the remote user is displayed on a top screen of a remote UI. This improves operability of the remote operation by the remote user. In the following embodiments, an information processing system including an image forming apparatus having a web server function and a VNC server function and a personal computer (PC) that is an information processing apparatus having a web browser function is explained as an example. In the information processing system, the PC can remotely operate the image forming apparatus by using a web browser to access the image forming apparatus and by connecting to a VNC server of the image forming apparatus via the web browser.

### First Embodiment

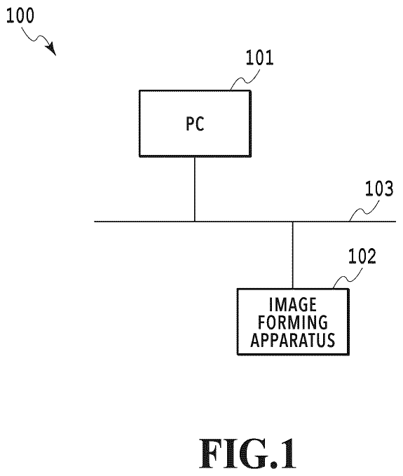

FIG. 1 is a diagram illustrating an example of a system configuration of an information processing system 100 according to a first embodiment. In the information processing system 100, an image forming apparatus 102 and a PC 101 are communicably connected to each other via a network 103. The image forming apparatus 102 has the web server function and the VNC server function, and transmits data of a display screen to the PC 101. The PC 101 has the web browser function, and receives the data of the display screen from the image forming apparatus 102 to display the data on a display unit of the PC 101. The network 103 includes a local area network (LAN), a wide area network (WAN), the Internet, and the like, and mediates communication between the image forming apparatus 102 and the PC 101. In the case where the image forming apparatus 102 and the PC 101 have a wireless communication function, the network 103 may be a wireless network.

In the following explanation, the image forming apparatus 102 is referred to as server, and the information processing apparatus such as the PC 101 or a mobile terminal connected to the server is referred to as client. Although an example in which the PC 101 is used as the information processing apparatus is explained in the present embodiment, the information processing apparatus only needs to have the web browser function, and is not limited to the PC 101. The information processing apparatus may be, for example, a mobile terminal such as a smartphone or a tablet, an image forming apparatus other than the image forming apparatus 102 that functions as the server, or the like. The image forming apparatus 102 may be a printer having a printing function or a multi-function peripheral (MFP) having a copy function, a transmission function, a FAX function, a saving function, and the like in addition to the printing function.

First, an outline of the remote connection in the information processing system 100 is explained. First, the image forming apparatus 102 launches a web server 330 to be described later and VNC server software to be described later. Then, the image forming apparatus 102 stands by for connection from the client. Next, the PC 101 displays a remote UI screen of the image forming apparatus 102 by using a web browser 502 to be described later. The remote UI is software that allows the user to perform various settings, operations of jobs, checking of a status of the image forming apparatus 102, and the like. In the case where the web browser 502 connects to the image forming apparatus 102 by designating a predetermined URL of the image forming apparatus 102, the image forming apparatus 102 performs processes based on the designated URL, and transmits web page data described in HTML, a scripting language, or the like to the client. URL is abbreviation of uniform resource locator, and HTML is abbreviation of hypertext markup language. The web browser 502 of the client forms a screen based on the received web page data, and displays the screen. In the following explanation, the web page data is also referred to as screen data. The communication between the image forming apparatus 102 and the web browser 502 of the client is performed according to hypertext transfer protocol (HTTP).

Link information to multiple functions included in the image forming apparatus is displayed on the remote UI screen. In the case where the user of the PC 101 designates the link information, the web browser 502 receives the screen data corresponding to the designated link information from the image forming apparatus 102 based on the designated link information, and displays the screen data on a display device of the PC 101. For example, in the case where link information to the remote operation is designated from multiple menus, the web browser 502 receives a screen of a remote operation function from the image forming apparatus 102, and displays the screen. The screen of the remote operation function is referred hereinafter as remote operation screen. Then, in the case where the user operates a start button displayed on the remote operation screen, a start process of the remote operation between the web browser 502 of the client and the image forming apparatus 102 is started. In the start process, the web browser 502 of the client communicates with a VNC server 320 via the web server 330 of the image forming apparatus 102. In the communication with the VNC server 320, a handshake process is performed first. In the handshake process, information is exchanged between the server and the client to establish VNC connection. After the establishment of the VNC connection, exchanging information such as the display screen and a screen operation between the server and the client enables remote operation of the server from the client.

The image forming apparatus 102 executes user authentication (login authentication) to limit users accessible to the image forming apparatus 102. Performing the user authentication allows usable functions to be changed depending on the user. For example, it is possible to assign usable functions based on privilege information of the user such as copy prohibited, all functions usable, and the like. Moreover, performing the user authentication allows use of a personalized function. The personalized function includes functions such as displaying a personal address book of the currently-logged-in user.

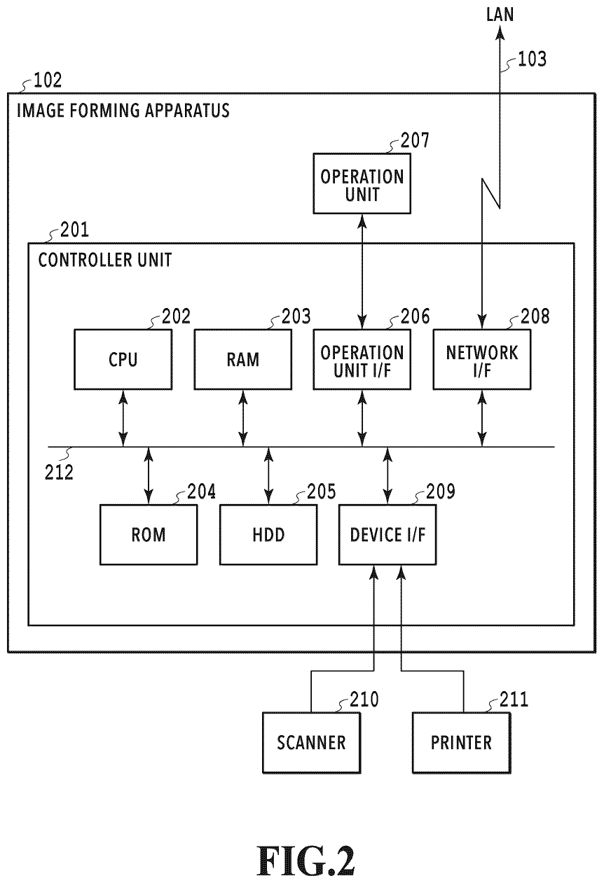

FIG. 2 is a hardware configuration diagram of the image forming apparatus 102. As illustrated in FIG. 2, the image forming apparatus 102 includes a controller unit 201, an operation unit 207, a scanner 210, and a printer 211. The controller unit 201 includes a CPU 202, a RAM 203, a ROM 204, a hard disk drive (HDD) 205, an operation unit I/F 206, a network I/F 208, and a device I/F 209. The operation unit 207 is connected to the controller unit 201 via the operation unit I/F 206. The scanner 210 and the printer 211 are connected to the controller unit 201 via the device I/F 209. Note that the configuration of the image forming apparatus 102 illustrated in FIG. 2 is an example, and may include constituent elements other than those described above.

In the controller unit 201 in the image forming apparatus 102, the CPU 202 is a computation device that controls the entire system. The CPU 202 integrally controls devices connected to a system bus 212. Note that, although there is one CPU in FIG. 2, the controller unit 201 may include multiple CPUs. Moreover, the controller unit 201 may include processors such as a graphics processing unit (GPU).

The ROM 204 is a non-volatile memory, and stores image data, other pieces of data, various programs for an operation of the CPU 202, and the like.

The RAM 203 is a volatile memory, and is used as a temporary storage region such as a main memory of the CPU 202 and a work area. Moreover, data and programs such as an operating system, system software, and application software are also arranged in the RAM 203.

The CPU 202 expands the programs stored in the ROM 204 and the like on the RAM 203, and executes the programs to control the units of the image forming apparatus 102. Note that the programs for the operation of the CPU 202 are not limited to those stored in the ROM 204, and programs stored in advance in the HDD 205 or the like may be used.

The HDD 205 stores the operating system, the system software, the application software, image data, setting data, and the like. The HDD 205 only needs to be capable of storing data, and other storage devices such as a solid state drive (SSD), a memory card, and an embedded multimedia card (eMMC) may be used as the HDD 205.

The operation unit I/F 206 is an interface unit to the operation unit 207, and outputs display information outputted from the CPU 202 to the operation unit 207. Moreover, the operation unit I/F 206 receives information inputted by the user from the operation unit 207, and inputs the information into the CPU 202. The operation unit 207 includes a touch panel and hard keys for receiving the user operation. The touch panel is a planarly-formed panel, and notifies the operation unit I/F 206 of coordinate information of a position touched by the user. The hard keys are keys capable of being physically pressed such as numerical keys, a start key, and a stop key, and notify the operation unit I/F 206 in the case where the keys are pressed. Moreover, the operation unit 207 includes a display that displays characters and images. The display receives a graphical user interface (GUI) screen generated by the CPU 202, from the operation unit I/F 206, and displays the GUI screen. Installing the touch panel integrally in an upper layer of the display allows the user to perform control as if the user is directly operating a screen displayed on the display.

The network I/F 208 is connected to the network 103, and performs input and output of information with the PC 101 connected on the same network.

The device I/F 209 connects the controller unit 201 to the scanner 210 and the printer 211 that are image input and output devices, and inputs and outputs image data.

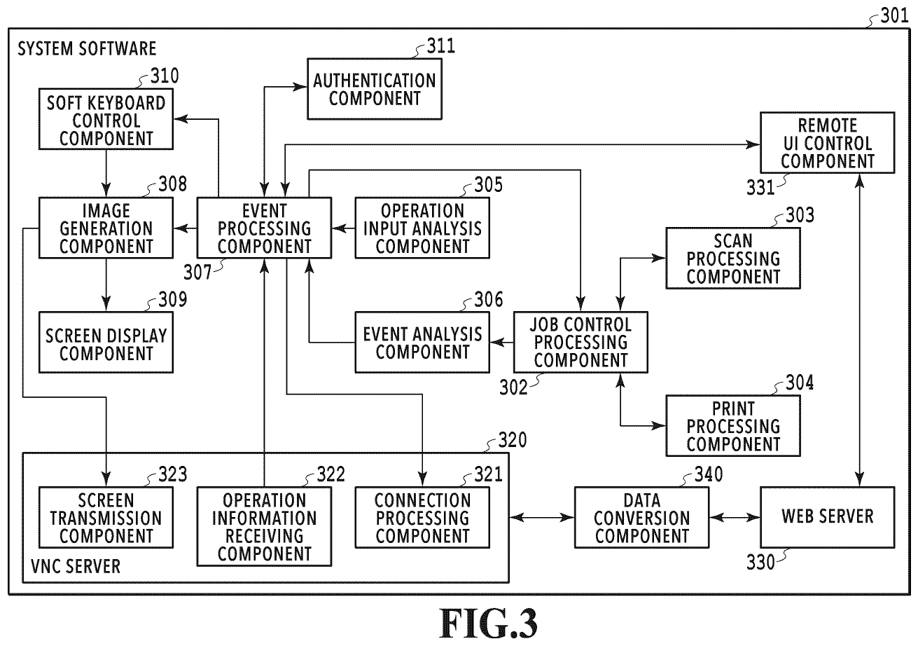

FIG. 3 is a software configuration diagram of the image forming apparatus 102. System software 301 is stored in one of storage units of the RAM 203, the ROM 204, and the HDD 205, and is executed by the CPU 202.

A job control processing component 302 controls software modules including not-illustrated software modules, and controls jobs executed by the image forming apparatus 102 such as copy, print, scan, and the like.

A scan processing component 303 controls the scanner 210 via the device I/F 209 based on an instruction of the job control processing component 302, and performs a process of reading an original placed on an original platen of the scanner 210.

A print processing component 304 controls the printer 211 via the device I/F 209 based on an instruction of the job control processing component 302, and performs a process of printing a designated image.

An operation input analysis component 305 analyzes information supplied from the operation unit 207 via the operation unit I/F 206, and notifies an event processing component 307 of an event corresponding to the user operation. The information analyzed in the operation input analysis component 305 is touching of the touch panel by the user and pressing of the hard keys by the user.

An event analysis component 306 receives various incidents occurring in the image forming apparatus 102 other than the operation input, from the job control processing component 302 and the like, analyzes the received incidents, and notifies the event processing component 307 of events corresponding to these incidents. The various incidents analyzed by the event analysis component 306 are incidents other than incidents caused by the user operation such as completion of a job and shortage of print sheets.

The event processing component 307 receives events from the operation input analysis component 305, the event analysis component 306, an operation information receiving component 322, a remote UI control component 331, or the like. The event processing component 307 notifies the job control processing component 302, an image generation component 308, or a soft keyboard control component 310 of the events, depending on the events, and controls the units of the image forming apparatus 102. Moreover, the event processing component 307 notifies an authentication component 311 of authentication information received from the operation input analysis component 305, and receives a result of a user authentication process from the authentication component 311. Furthermore, the event processing component 307 notifies a connection processing component 321 of disconnection of the VNC connection.

The image generation component 308 performs a process of generating data of a screen to be display on the display, on the RAM 203.

A screen display component 309 reads the data of the screen generated by the image generation component 308, from the RAM 203, and displays the data on the display of the operation unit 207 via the operation unit I/F 206.

The soft keyboard control component 310 performs control of displaying a soft keyboard screen by receiving a notification from the event processing component 307. Moreover, the soft keyboard control component 310 holds information indicating whether the soft keyboard is displayed on the display or not.

The authentication component 311 performs the user authentication process including a login process or a logout process by receiving the authentication information from the event processing component 307, and sends back a result of the user authentication process.

The VNC server 320 is a software module having a function for performing a remote operation of the operation unit 207 from the PC 101, and includes the connection processing component 321, the operation information receiving component 322, and a screen transmission component 323. The VNC server 320 exchanges information on the remote operation, with a data conversion component 340.

The connection processing component 321 performs a start process for starting the VNC connection in response to a start instruction of the remote operation from the data conversion component 340, and establishes the VNC connection. Moreover, the connection processing component 321 receives notification of VNC disconnection from the event processing component 307, and performs a termination process including disconnection of the VNC connection.

The operation information receiving component 322 receives operation information of VNC from the data conversion component 340, and notifies the event processing component 307 of an event corresponding to a user operation. Note that the event which is notified of by the operation information receiving component 322 is equivalent to the event which is notified of by the operation input analysis component 305, and is an event for allowing the user to operate the image forming apparatus 102.

The screen transmission component 323 reads the image data generated by the image generation component 308, from the RAM 203, and performs a process of transmitting the image data to the data conversion component 340.

Moreover, in the case where a not-illustrated VNC client is installed in the PC 101, the units of the VNC server 320 can perform communication with the VNC client via the network 103.

The web server 330 receives a HTTP request transmitted by the web browser 502 via the network 103. Then, the web server 330 analyzes the received data, and requests the remote UI control component 331 or the data conversion component 340 to perform a process depending on a result of the analysis. Specifically, if the received data is data relating to VNC in the result of the data analysis, the web server 330 requests the data conversion component 340 to perform a process. If not, the web server 330 requests the remote UI control component 331 to perform a process. Moreover, the web server 330 receives a response from the remote UI control component 331 or the data conversion component 340. Then, the web server 330 transmits the received response to the web browser 502 via the network 103.

The remote UI control component 331 receives a request of a process from the web server 330. Then, the remote UI control component 331 notifies the event processing component 307 according to the received request. Moreover, the remote UI control component 331 receives notification from the event processing component 307, and responds to the web server 330.

The data conversion component 340 exchanges information on the VNC with the web server 330 and the VNC server 320.

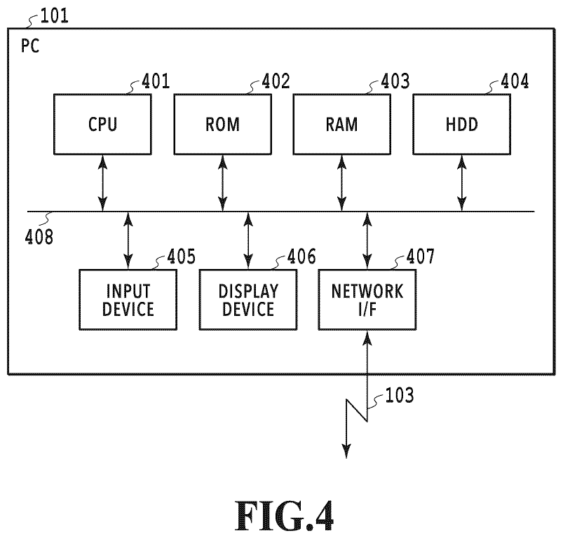

FIG. 4 is a hardware configuration diagram of the PC 101. As illustrated in FIG. 4, the PC 101 includes a CPU 401, a ROM 402, a RAM 403, an HDD 404, an input device 405, a display device 406, and a network I/F 407. Note that the configuration of the PC 101 illustrated in FIG. 4 is an example, and may include constituent elements other than those described above.

In the PC 101, the CPU 401 is a computation device that controls the entire system. The CPU 401 integrally controls devices connected to a system bus 408. Note that, although there is one CPU in FIG. 4, the PC 101 may include multiple CPUs. Moreover, the PC 101 may include processors such as a graphics processing unit (GPU).

The ROM 402 is a non-volatile memory, and stores image data, other pieces of data, various programs for an operation of the CPU 401, and the like.

The RAM 403 is a volatile memory, and is used as a temporary storage region such as a main memory of the CPU 401 and a work area. Moreover, data and programs such as an operating system, system software, and application software are also arranged in the RAM 403.

The CPU 401 expands the programs stored in the ROM 402 and the like on the RAM 403, and executes the programs to control the units of the PC 101. Note that the programs for the operation of the CPU 401 are not limited to those stored in the ROM 402, and programs stored in advance in the HDD 404 or the like may be used.

The HDD 404 stores the operating system, the system software, the application software, photographs, electronic documents, setting data, and the like. The HDD 404 only needs to be capable of storing data, and other storage devices such as an SSD, an SD memory card, or an eMMC may be used as the HDD 404.

The input device 405 is a keyboard and a pointing device that receive input of instructions to the PC 101 by the user, and inputs inputted information into the CPU 401.

The display device 406 includes a display and a display control circuit, and displays the display information outputted from the CPU 401. The remote UI screen and the remote operation screen obtained from the web server 330 via the web browser 502 are displayed on the display device 406. An operation status of the image forming apparatus 102 and information outputted by each of the programs operating on the PC 101 are displayed on these screens.

The network I/F 407 is connected to the network 103, and performs input and output of information with other PCs and the image forming apparatus 102 connected on the same network.

The above-mentioned elements are arranged on the system bus 408. Note that the CPU 401 executes processes based on programs corresponding to the operating system and the applications stored in the HDD 404 to achieve functions (or processes) of the operating system and the applications.

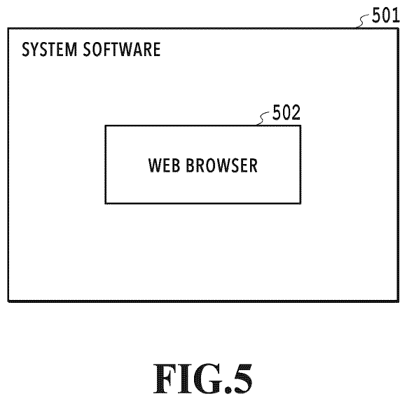

FIG. 5 is a software configuration diagram of the PC 101. System software 501 is stored in one of storage units of the RAM 403, the ROM 402, and the HDD 404, and is executed by the CPU 401.

As illustrated in FIG. 5, the system software 501 includes the web browser 502. The web browser 502 makes a request of obtaining web contents to the web server 330. Moreover, the web browser 502 provides a function of analyzing HTML of the web contents obtained from the web server 330 and displaying the web contents in the display device 406, a function of analyzing and executing Java Script (registered trademark), and the like.

Moreover, the system software 501 may include the not-illustrated VNC client. The VNC client communicates with the units of the VNC server 320 via the network 103.

### Functional Configuration of Information Processing System

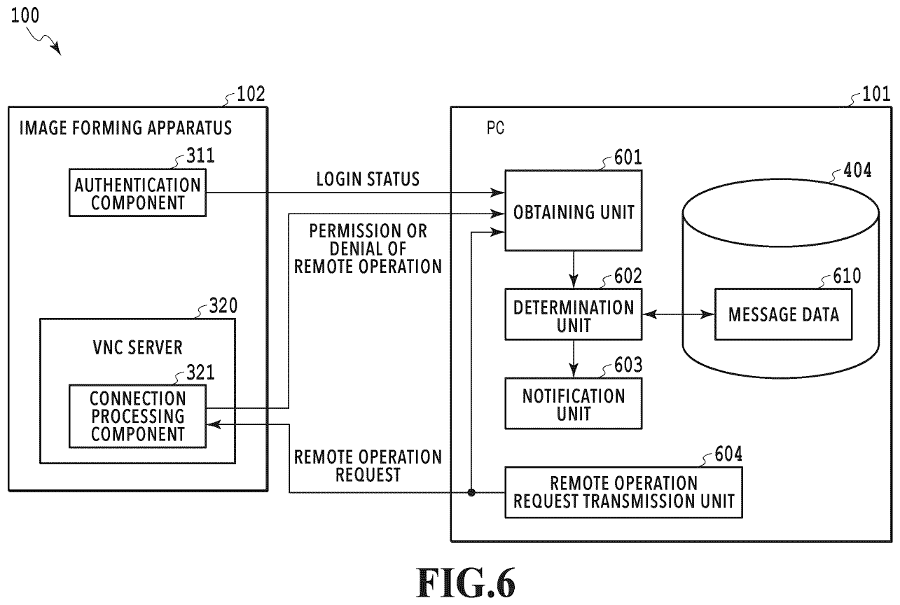

Next, a functional configuration of the information processing system 100 according to the embodiment of the present disclosure is explained with reference to FIG. 6. As illustrated in FIG. 6, the PC 101 includes an obtaining unit 601, a determination unit 602, a notification unit 603, and a remote operation request transmission unit 604. Moreover, message data 610 including multiple candidates of messages are stored in the HDD 404 of the PC 101.

The obtaining unit 601 obtains first information indicating a state of the remote operation between the PC 101 and the image forming apparatus 102 and second information indicating a use status of the image forming apparatus 102. The first information is determined based on whether the start instruction of the remote operation is transmitted from the PC 101 to the image forming apparatus 102 or not or the response (connection permitted/connection denied) to the start instruction of the remote operation from the image forming apparatus 102. The start instruction of the remote operation and the response to the start instruction are exchanged between the remote operation request transmission unit 604 and the VNC server 320 via the web browser 502 of the PC 101 in the present embodiment.

The remote operation state indicated by the first information is specifically one of “before start”, “preparation ongoing”, or “ongoing”. “Before start” is a state before execution of the operation of the start instruction of the remote operation in the PC 101 or a state after reception of a response to the effect that the remote connection is not permitted from the image forming apparatus 102. “Preparation ongoing” is a state after execution of the operation of the start instruction of the remote operation in the PC 101 by the user and transmission of the start instruction of the remote operation to the image forming apparatus 102 by the remote operation request transmission unit 604 and before reception of the response indicating permission or non-permission of the remote operation from the image forming apparatus 102. “Ongoing” is a state where the remote operation is executable as a result of the start instruction of the remote operation and the response.

The use status of the image forming apparatus 102 indicated by the second information is information indicating whether a user logged in the image forming apparatus 102 other than the user of the PC 101 is present or not. In the case where a user logged in the image forming apparatus 102 is present, that is a user using the image forming apparatus 102 is present, the second information is “login user present”. In the case where a user logged in the image forming apparatus 102 is absent, that is a user using the image forming apparatus 102 is absent, the second information is “login user absent”. The second information can be obtained from the authentication component 311 of the image forming apparatus 102 via the web server 330 and the web browser 502.

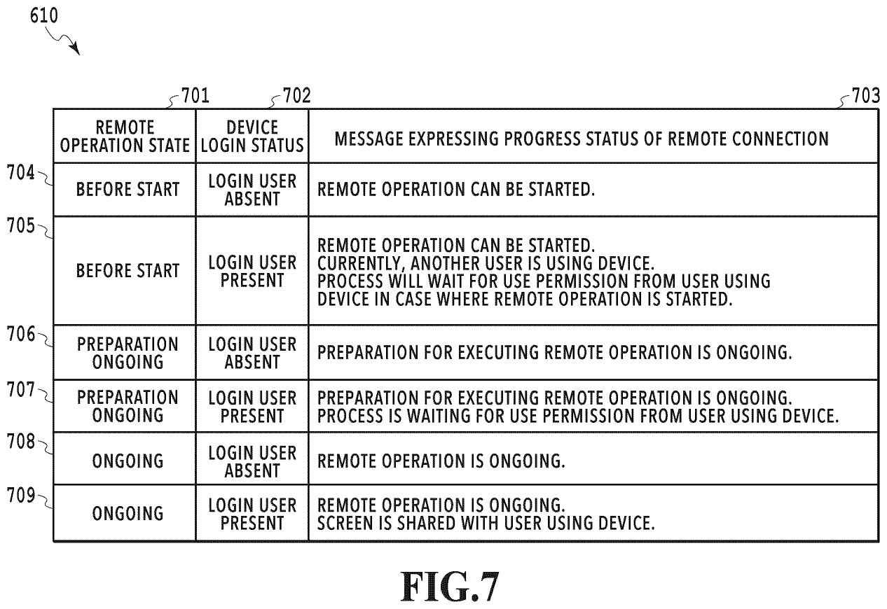

The determination unit 602 determines notification information which the user of the PC 101 is to be notified of, based on the first information and the second information obtained by the obtaining unit 601. The determination unit 602 determines a message (notification information) corresponding to the first information and the second information obtained by the obtaining unit 601, from the plurality of pieces of message data 610 stored in advance in the HDD 404. FIG. 7 is a diagram illustrating examples of candidates of the message data 610. As illustrated in FIG. 7, a remote operation state 701 that is the first information, a device login status 702 that is the second information, and a message 703 expressing a progress status of the remote connection are stored in the message data 610 in association with one another. The device herein is the image forming apparatus 102 connected to the PC 101. The message data 610 is described later.

The notification unit 603 notifies the user of the PC 101 of the notification information (message) determined by the determination unit 602. The notification is performed such that the web browser 502 displays the notification information (message) in the display device 406 of the PC 101 in a browsable manner. The determination unit 602 and the notification unit 603 first determine the message to be displayed and display the determined message before the execution of the operation of the start instruction of the remote operation. For example, the determination unit 602 determines the message to be displayed, at a stage where a “remote operation” menu is selected on the remote UI screen. The notification unit 603 displays the determined message on the remote UI screen. At this stage, since the operation of the start instruction of the remote operation is not executed, the remote operation state (first information) is “before start”. In the case where the device login status at this stage is “login user absent”, a message “remote operation can be started” is displayed. In the case where the device login status is “login user present”, a message “remote operation can be started. Currently, another user is using device. Process will wait for use permission from user using device in case where remote operation is started” is displayed.

Moreover, in the case where at least one of the first information and the second information is changed, the notification unit 603 updates the notification information. Specifically, the notification unit 603 updates the notification information after transmission of the start instruction of the remote operation to the image forming apparatus 102. This is because the remote operation state changes from “before start” to “preparation ongoing”. Moreover, the notification unit 603 updates the notification information after the state where the remote operation executable is established. This is because the remote operation state changes from “preparation ongoing” to “ongoing”. The state where the remote operation is executable is a state where the VNC connection is established. Moreover, the notification unit 603 updates the notification information after transmission of a termination instruction of the remote operation to the image forming apparatus 102 or in the case of disconnection of the remote connection. This is because the remote operation state changes from “ongoing” or “preparation ongoing” to “before start”.

In the case where the remote operation state indicated by the first information is “before start” or “preparation ongoing” and the use status of the image forming apparatus 102 indicated by the second information is “login user present”, the notification information includes information of standby for use permission from the user logged in the image forming apparatus.

In the case where the remote operation state indicated by the first information is “ongoing” and the use status of the image forming apparatus 102 indicated by the second information is “login user present”, the notification information includes information indicating that the operation screen is shared with the user logged in the image forming apparatus 102.

In the case where the user of the PC 101 performs the operation of the start instruction of the remote operation, the remote operation request transmission unit 604 transmits the start instruction of the remote operation to the image forming apparatus 102. In the case where the image forming apparatus 102 receives the start instruction of the remote operation from the PC 101, the connection processing component 321 executes a connection process of the remote operation.

The connection processing component 321 determines whether the execution of the remote operation is possible or not, in the connection process of the remote operation, and sends back a response indicating whether the remote operation is possible or not, to the PC 101. The response indicating whether the remote operation is possible or not is a response of connection permitted or connection denied. In the case where the user using (logged in) the image forming apparatus 102 is present at the moment of reception of the start instruction of the remote operation, the connection processing component 321 inquires of the user of the image forming apparatus 102 whether or not to permit use of the image forming apparatus 102 by the remote user. The response of permitting or denying the remote operation by the remote user (user of the PC 101) is determined depending on an answer to this inquiry. In the case where the answer to the inquiry indicates permission of the remote operation and in the case where the answer to the inquiry indicates permission of the remote operation with the operation of the user continued, the connection processing component 321 sends back “connection permitted”. In the case where the answer to the inquiry indicates denial of the remote operation, the connection processing component 321 sends back “connection denied”. The connection processing component 321 (VNC server 320) transmits the determined response to the PC 101.

The authentication component 311 determines whether to continue the login of the user using the image forming apparatus 102 or to perform logout, depending on the answer to the inquiry of whether or not to permit use of the image forming apparatus 102. In the case where the answer to the inquiry indicates permission of the remote operation, the authentication component 311 performs the logout of the user. This means handing over the right to operate the image forming apparatus 102 to the remote user. In the case where the answer to the inquiry indicates denial of the remote operation, the authentication component 311 maintains the login state of the user. This means that the right to operate the image forming apparatus 102 is not handed over to the remote user, and the operation is continued. Moreover, also in the case where the answer to the inquiry indicates permission of the remote operation by the remote user with the operation of the user continued, the login state of the user is maintained. This case means that the user currently logged in the image forming apparatus 102 and the remote user share the same operation screen. In the case where the login status changes, the authentication component 311 transmits the login status to the PC 101 via the web server 330.

In the case where the user using (logged in) the image forming apparatus 102 is absent at the moment of reception of the start instruction of the remote operation, the connection processing component 321 does not perform the above-mentioned inquiry, and transmits the response to the effect that the remote operation is permitted, to the PC 101.

In the case where the remote operation request transmission unit 604 transmits the start instruction of the remote operation, the obtaining unit 601 of the PC 101 changes the remote operation state from “before start” to “preparation ongoing”, and stores the remote operation state in the RAM 403. Moreover, in the case where the obtaining unit 601 receives the response to the start instruction of the remote operation from the image forming apparatus 102, the obtaining unit 601 determines the remote operation state (first information). In the case where the obtaining unit 601 receives the response of permitting the remote operation, the obtaining unit 601 changes the remote operation state from “preparation ongoing” to “ongoing”, and stores the remote operation state in the RAM 403. In the case where the obtaining unit 601 receives a response of denying the remote operation, the obtaining unit 601 changes the remote operation state from “preparation ongoing” back to “before start”, and stores the remote operation state in the RAM 403. Note that, before the transmission of the start instruction of the remote operation by the remote operation request transmission unit 604, the obtaining unit 601 stores “before start” as the remote operation state in the RAM 403.

Moreover, in the case where the login process or processes such as the logout is performed in the authentication component 311 and the login status changes, the image forming apparatus 102 transmits the information indicating the login status to the PC 101. The obtaining unit 601 of the PC 101 obtains the login status transmitted from the image forming apparatus 102, and stores the login status in the RAM 403.

FIG. 7 is a diagram illustrating examples of candidates of the message data 610. As illustrated in FIG. 7, the remote operation state 701, the device (image forming apparatus 102) login status 702, and the message 703 expressing the progress status of the remote connection are stored in the message data 610 in association with one another.

For example, as illustrated in a row 704, “remote operation can be started” is associated as the message 703 in the case where the remote operation state 701 is “before start” and the device login status 702 is “login user absent”. The case where the device login status 702 is “login user absent” means that the user logged in the image forming apparatus 102 is absent. The case where the device login status 702 is “login user present” means that one or more user logged in the image forming apparatus 102 is present. In a row 705, “remote operation can be started. Currently, another user is using device. Process will wait for use permission from user using device in case where remote operation is started” is associated as the message 703 in the case where the remote operation state 701 is “before start” and the device login status 702 is “login user present”.

In a row 706, “preparation for executing remote operation is ongoing” is associated as the message 703 in the case where the remote operation state 701 is “preparation ongoing” and the device login status 702 is “login user absent”. In a row 707, “preparation for executing remote operation is ongoing. Process is waiting for use permission from user using device” is associated as the message 703 in the case where the remote operation state 701 is “preparation ongoing” and the device login status 702 is “login user present”.

In a row 708, “remote operation is ongoing” is associated as the message 703 in the case where the remote operation state 701 is “ongoing” and the device login status 702 is “login user absent”. In a row 709, “remote operation is ongoing. Screen is shared with user using device” is associated as the message 703 in the case where the remote operation state 701 is “ongoing” and the device login status 702 is “login user present”.

Note that these messages are merely examples, and texts of the messages are not limited to those in the examples of FIG. 7. Although three types of the remote operation state of “before start”, “preparation ongoing”, and “ongoing” are illustrated, states other than those described above may be included.

### Remote Operation

Next, a process in which the operation unit 207 of the image forming apparatus 102 is remotely operated by using the web browser 502 of the PC 101 is explained in detail with reference to flowcharts and illustrated examples.

First, setting of the remote operation in the image forming apparatus 102 is explained. This setting is performed to enable the remote operation of the image forming apparatus 102 from the PC 101. Generally, a user who has administrator rights of the image forming apparatus 102 performs this setting operation. In the case where the user turns on the power of the image forming apparatus 102, the controller unit 201 of the image forming apparatus 102 launches the VNC server 320 and the web server 330. In a launch process of the VNC server, the connection processing component 321 refers to setting information 800 relating to VNC stored in an HDD 205 and determines whether a remote operation setting 801 is enabled (ON) or not. The setting information 800 relating to VNC may be set in advance by the administrator of the image forming apparatus 102, or may be set at any timing. In the setting of the setting information 800 relating to VNC, the CPU 202 of the image forming apparatus 102 displays a remote operation setting screen 900 on the operation unit 207, and performs a setting process relating to VNC.

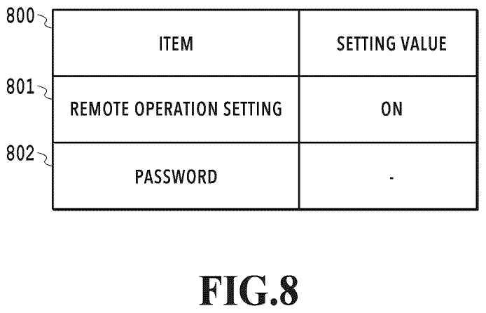

FIG. 8 is a diagram illustrating an example of the setting information 800 relating to VNC. A setting value of the remote operation setting 801 and a value of a password 802 are stored in the setting information 800 relating to VNC. One of enabled (ON) and disabled (OFF) is stored in the setting value of the remote operation setting 801. The password is a password for enabling a setting operation in the remote operation setting screen 900, and is set by the administrator. The example of FIG. 8 illustrates that the setting value of the remote operation setting 801 is “ON” and the value of the password 802 is not set. In the case where the setting value of the remote operation setting 801 is enabled (ON), the connection processing component 321 opens a port for VNC connection, and stands by for connection from the client. The configuration may be such that, in the case where the setting value of the remote operation setting 801 is disabled (OFF), the connection processing component 321 waits until the remote operation setting 801 is enabled (ON), and then opens the port for VNC connection and stands by for connection from the client.

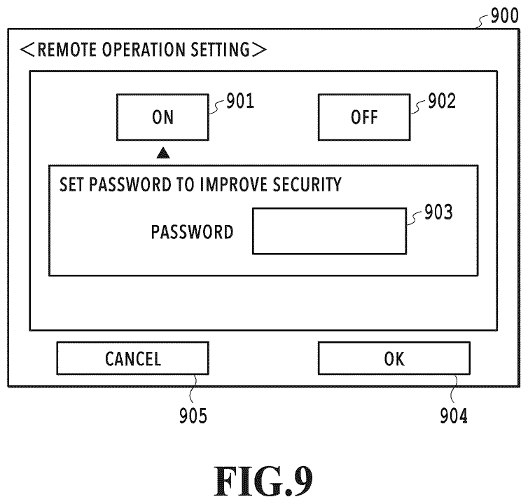

FIG. 9 is a diagram illustrating an example of the remote operation setting screen 900. The remote operation setting screen 900 is provided with an ON button 901 and an OFF button 902. The ON button 901 is selected in the case where VNC is to be used in the image forming apparatus 102. Setting of the password by the administrator may be received in the case where the ON button 901 is selected. The OFF button 902 is selected in the case where VNC is not to be used in the image forming apparatus 102. A password field 903 is an input field of an administrator password used in a VNC authentication process. An OK button 904 is used to finalize the setting in the remote operation setting screen 900. A cancel button 905 is used to cancel setting changes in the remote operation setting screen. In the case where the user changes settings of the ON button 901, the OFF button 902, and the password field 903 and the OK button 904 is operated, the CPU 202 of the image forming apparatus 102 saves the changed setting values in the HDD 205. In the case where the user operates the cancel button 905, the CPU 202 closes the remote operation setting screen 900, and returns to an original screen.

The setting values set in the remote operation setting screen 900 are managed as the setting information 800 relating to VNC, and are held in the HDD 205. The setting information 800 relating to VNC can be referred to at any timing. Note that the web server 330 may also be similarly configured such that whether the web server is to be used or not can be set by using a not-illustrated setting screen of the web server, and a setting value is saved in the HDD 205. Moreover, the web server 330 may be configured such that, in a launch process of the web server 330, the CPU 202 refers to the setting value, and in the case where the setting value is enabled (ON), opens a port of the web server and stands by for connection from the client.

### Display Process of Remote UI Screen

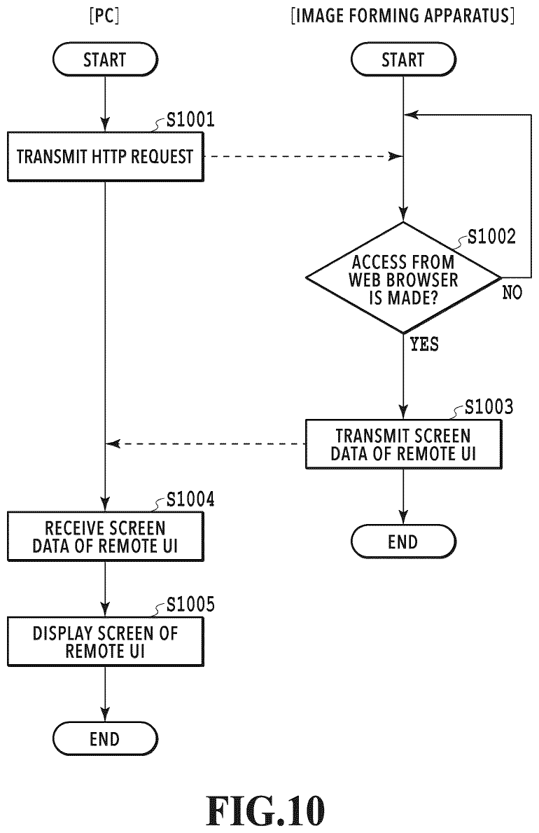

A display process of the remote UI screen in the information processing system 100 is explained with reference to FIG. 10. In the present embodiment, the web browser 502 of the PC 101 is used to display the remote UI screen. The left portion of FIG. 10 is a flowchart explaining a process executed by the CPU 401 of the PC 101. The right portion of FIG. 10 is a flowchart explaining a process executed by the CPU 202 of the image forming apparatus 102. These flowcharts are started in the case where the user inputs a URL (for example, IP address) of the image forming apparatus 102 into the web browser 502.

In S1001, the user operates the web browser 502 by using the display device 406 and the input device 405 of the PC 101. In the case where the web browser 502 detects input of the URL of the image forming apparatus 102 by the user, the web browser 502 transmits the HTTP request to the web server 330 by using the inputted URL of the image forming apparatus 102.

The web server 330 of the image forming apparatus 102 stands by for access from the web browser 502. In S1002, the web server 330 determines whether the access from the web browser 502 is made. Specifically, in the case where the web server 330 receives the HTTP request from the web browser 502 in S1002, the web server 330 determines that the access from the web browser 502 is made. If the web server 330 determines that the access from the web browser 502 is made in S1002, the process proceeds to S1003. If the web server 330 determines that the access from the web browser 502 is not made, the web server 330 repeats the process of S1002.

In S1003, the web server 330 requests the remote UI control component 331 to perform a process. This request is a request for a screen of the remote UI. The remote UI control component 331 transmits screen data of the remote UI to the web server 330. The web server 330 transmits the screen data of the remote UI to the web browser 502, and terminates the process of the flowchart in the right portion of FIG. 10.

In S1004, the web browser 502 receives the screen data of the remote UI transmitted from the web server 330, as a response to the HTTP request transmitted in S1001.

In S1005, the web browser 502 analyzes the received screen data of the remote UI, displays the screen of the remote UI in the display device 406, and terminates the process of the flowchart in the left portion of FIG. 10.

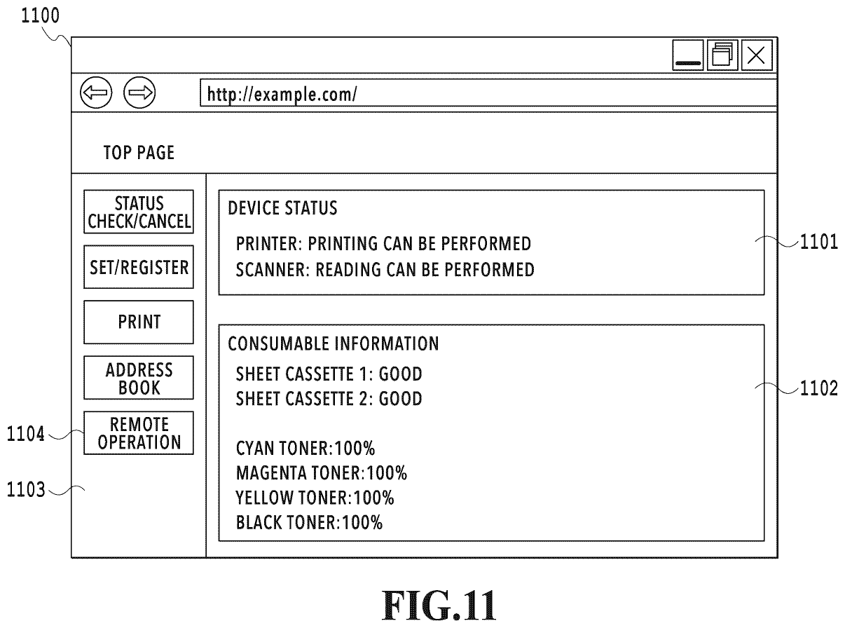

FIG. 11 is a diagram illustrating an example of the remote UI screen displayed by the web browser 502 of the PC 101. In the example of FIG. 11, a top screen 1100 (top page) of the remote UI is illustrated. As described above, the top screen 1100 of the remote UI is a screen displayed in S1005 by the web browser 502 which receives, in S1004, the screen data transmitted by the image forming apparatus 102 in S1003.

The top screen 1100 of the remote UI includes a device status display region 1101, a consumable information display region 1102, and a menu region 1103. Information indicating the states of the scanner 210 and the printer 211 of the image forming apparatus 102 is displayed in the device status display region 1101. In the consumable information display region 1102, types and remaining amounts of sheets and inks are displayed as information on consumables. Link buttons to pages of processes are displayed in the menu region 1103. The link buttons of the menu region 1103 include a link button 1104 to the remote operation. The link button 1104 to the remote operation is a button for invoking the remote operation function. The link button 1104 to the remote operation may be displayed only in the case where the remote operation setting 801 is set to enabled (ON). Moreover, in the case where the user authentication (login authentication) is used in the image forming apparatus 102, the CPU 202 of the image forming apparatus 102 may determine whether to display the link button 1104 to the remote operation, based on the user information of the currently-logged-in user. For example, the link button 1104 to the remote operation may be displayed only in the case where the user who has caused the web browser 502 to display the top screen 1100 of the remote UI has the access rights of the administrator. Alternatively, the configuration may be such that a user right for use of the remote operation function is set in advance, and the link button 1104 to the remote operation is displayed depending on the right of the user who has caused the web browser 502 to display the top screen 1100 of the remote UI. In this case, the right of the user who can execute the remote operation may be set such as administrator only, all user permitted, or the like.

### Display Process of Remote Operation Screen

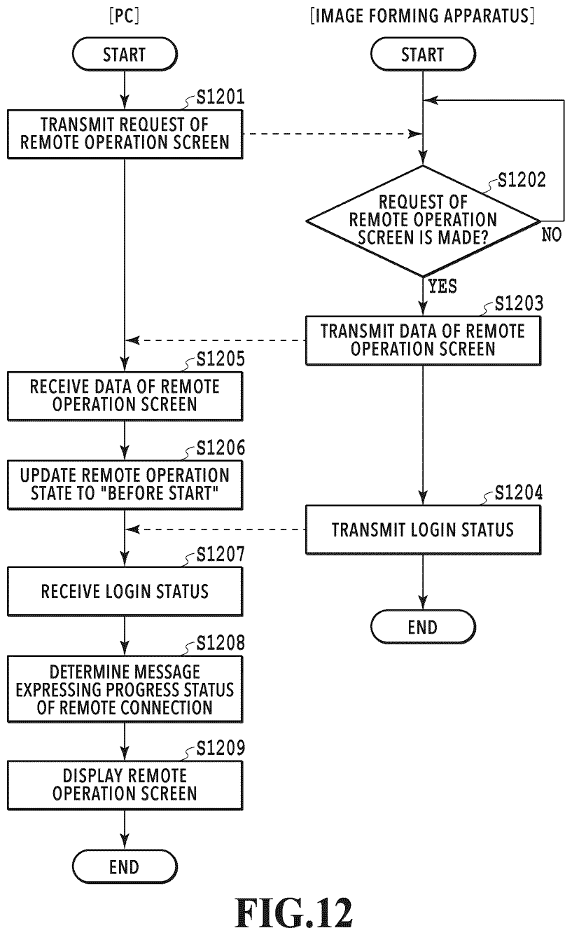

The display process of the remote operation screen in the information processing system 100 is explained with reference to FIG. 12. The left portion of FIG. 12 is a flowchart explaining a process executed by the CPU 401 of the PC 101. The right portion of FIG. 12 is a flowchart explaining a process executed by the CPU 202 of the image forming apparatus 102. These flowcharts are started in the case where the user gives an instruction to display the remote operation screen. In the present embodiment, the instruction to display the remote operation screen is inputted by the user operation on the link button 1104 to the remote operation displayed on, for example, the top screen 1100 of the remote UI.

In S1201, in the case where the pressing of the link button 1104 to the remote operation is detected, the web browser 502 of the PC 101 transmits an HTTP request requesting the remote operation screen, to the web server 330 of the image forming apparatus 102.

The web server 330 of the image forming apparatus 102 is standing by for the request of the remote operation screen from the web browser 502 of the PC 101. In S1202, the web server 330 determines whether the request of the remote operation screen is made from the web browser 502 or not. Specifically, in S1202, in the case where the web server 330 receives the HTTP request requesting the remote operation screen from the web browser 502, the web server 330 determines that the request of the remote operation screen is made from the web browser 502. If the web server 330 determines that the request of the remote operation screen is made from the web browser 502 in S1202, the process proceeds to S1203. If the web server 330 determines that the request of the remote operation screen is not made from the web browser 502, the web server 330 repeats the process of S1202.

In S1203, the web server 330 requests the remote UI control component 331 to perform a process. Since this request is the request of the remote operation screen, the remote UI control component 331 transmits the screen data of the remote operation screen to the web server 330. The web server 330 transmits the received screen data of the remote operation screen to the web browser 502.

Next, in S1204, the web server 330 causes the remote UI control component 331 to obtain the information indicating the login status of the image forming apparatus 102, from the authentication component 311 via the event processing component 307. The information indicating the login status includes information on presence or absence of the logged-in user and the like. Note that the information indicating the login status is not limited to this, and may include, for example, a user name, login time and date, a login time period, and the like. The web server 330 transmits the obtained information indicating the login status to the web browser 502, and terminates the process of the flowchart in the right portion of FIG. 12.

In S1205, the web browser 502 of the PC 101 receives the screen data of the remote operation screen transmitted from the web server 330 in S1203, as a response to the HTTP request.

Since the web browser 502 has only received the screen data of the remote operation screen at this stage, in S1206, the web browser 502 saves the remote operation state as “before start” in the RAM 203.

In S1207, the web browser 502 receives the login status transmitted from the web server 330 in S1204.

In S1208, the web browser 502 determines the message expressing the progress status of the remote connection, based on the remote operation state and the login status of the image forming apparatus 102.

In S1209, the web browser 502 displays the remote operation screen on the display device 406 of the PC 101 based on the screen data received in S1205, and terminates the process illustrated in the flowchart in the left portion of FIG. 12.

Note that, although the example in which the screen data of the remote operation screen and the information indicating the login status are transmitted separately in S1203 to S1204 is explained as an example in the flowchart illustrated in FIG. 12, the present disclosure is not limited to this. The screen data of the remote operation screen and the information indicating the login status may be transmitted together in one operation.

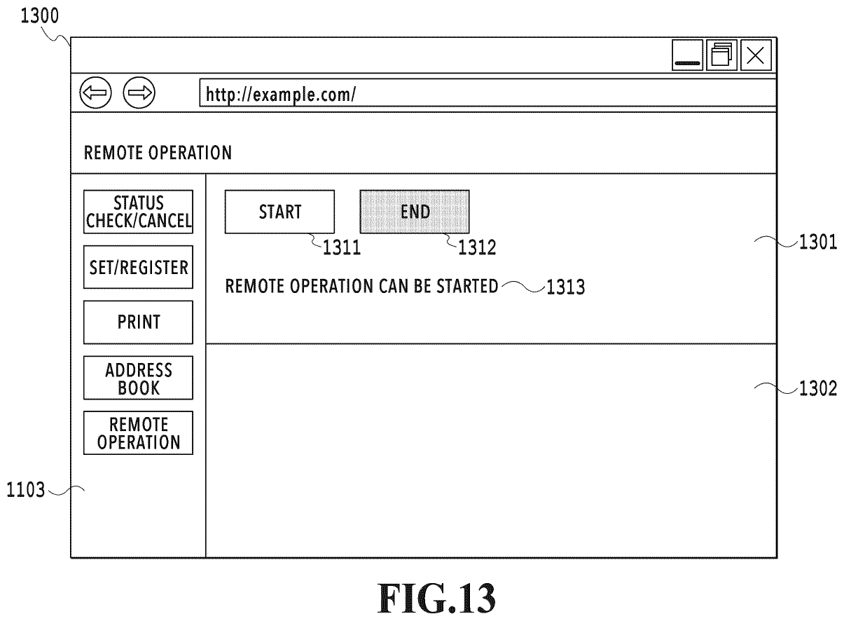

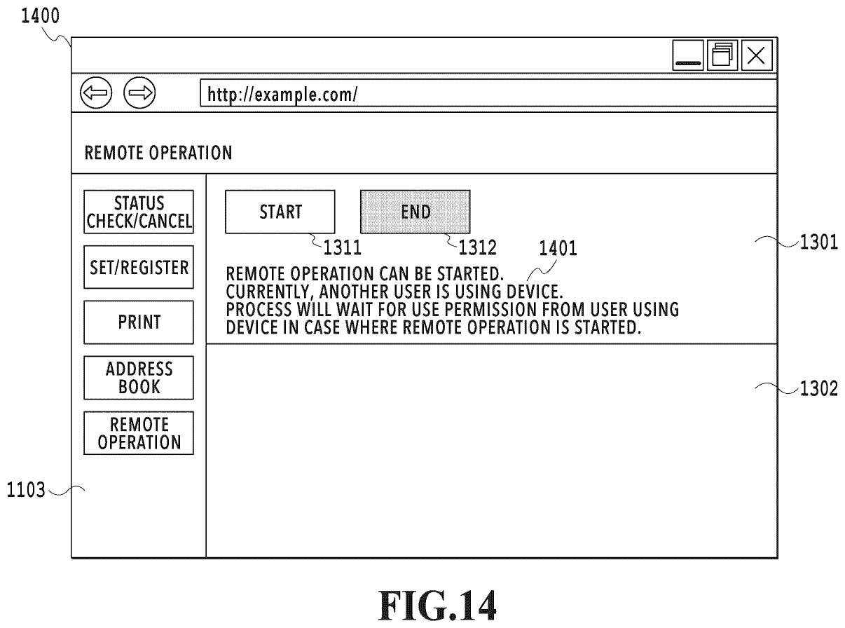

FIGS. 13 and 14 are examples of the remote operation screen displayed in S1209. In the case where the information indicating the login status received in S1207 is “login user absent”, a first remote operation screen 1300 illustrated in FIG. 13 is displayed in the display device 406 of the PC 101. In the case where the information indicating the login status received in S1207 is “login user present”, a second remote operation screen 1400 illustrated in FIG. 14 is displayed.

The first remote operation screen 1300 and the second remote operation screen 1400 are each provided with the menu region 1103, an operation region 1301, and an operation screen display region 1302. The menu region 1103 is the same as the menu region of the remote UI screen illustrated in FIG. 11. A start button 1311, an end button 1312, and a message 1313 are displayed in the operation region 1301. The start button 1311 is a button for starting the remote operation. The end button 1312 is a button for terminating the remote operation. As described above, since the remote operation state is “before start” and the remote operation is terminated, the end button 1312 is displayed with its color changed, and expresses that the end button 1312 is in a selected state. The message 1313 is a message expressing the progress status of the remote connection. The message determined in S1208 is displayed in the message 1313. The same screen as the screen displayed in the operation unit 207 of the image forming apparatus 102 is displayed in the operation screen display region 1302 in the case where the remote operation state is “ongoing”. Since the first remote operation screen 1300 and the second remote operation screen 1400 are screens displayed in the case where the remote operation state is “before start”, nothing is displayed in the operation screen display region 1302.

The message of the row 704 in FIG. 7 is displayed in the message 1313 displayed on the first remote operation screen 1300 illustrated in FIG. 13. This is because the remote operation state 701 is “before start”, and the device login status 702 is “login user absent”. Specifically, “remote operation can be started” is displayed. The remote user referring to this message can recognize that the remote operation can be started without particular restrictions.

The message of the row 705 in FIG. 7 is displayed in a message 1401 displayed on the second remote operation screen 1400 illustrated in FIG. 14. This is because the remote operation state 701 is “before start”, and the device login status 702 is “login user present”. Specifically, “remote operation can be started. Currently, another user is using device. Process will wait for use permission from user using device in case where remote operation is started” is displayed. The remote user referring to this message can recognize that another user is currently logging in the image forming apparatus 102 and using the image forming apparatus 102. Moreover, the remote user can recognize that, in the case where the remote user starts the remote operation, the process will stand by for the use permission from the other user, and immediate start of the remote operation thus may not be possible.

### Start Process of Remote Operation

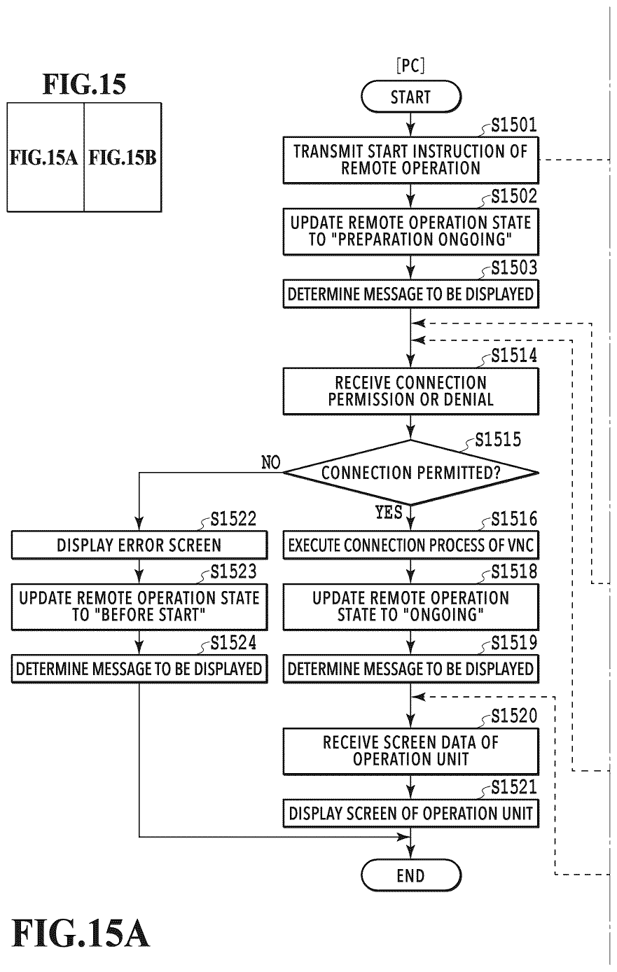

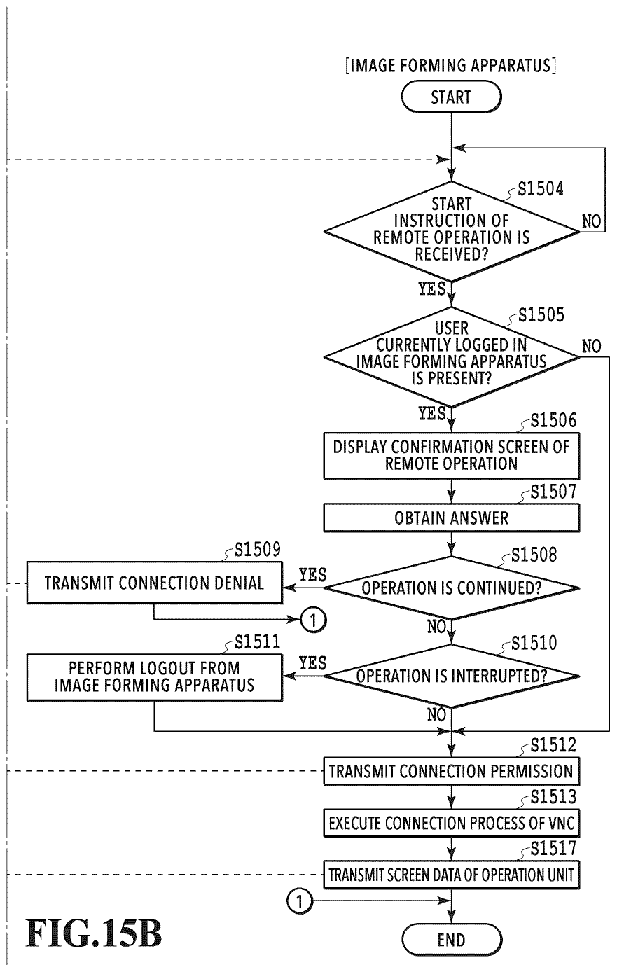

Next, the start process of the remote operation is explained with reference to FIGS. 15 to 21.

FIGS. 15A and 15B are totally a flowchart illustrating a flow of the start process of the remote operation executed in the information processing system 100. FIG. 15A is a flowchart explaining a process executed by the CPU 401 of the PC 101. FIG. 15B is a flowchart explaining a process executed by the CPU 202 of the image forming apparatus 102. These flowcharts are started in the case where the user inputs an instruction to start the remote operation. In the present embodiment, the instruction to start the remote operation is inputted by a user operation on the start button 1311 displayed on the first remote operation screen 1300 or the second remote operation screen 1400.

In S1501, the web browser 502 of the PC 101 transmits the HTTP request requesting the start of the remote operation to the web server 330 in the case where the pressing of the start button 1311 is detected. In S1502, the web browser 502 updates the remote operation state to “preparation ongoing”, and saves the remote operation state in the RAM 203. In S1503, the web browser 502 determines the message expressing the progress status of the remote connection based on the remote operation state 701 and the device login status 702, and updates the message to be displayed.

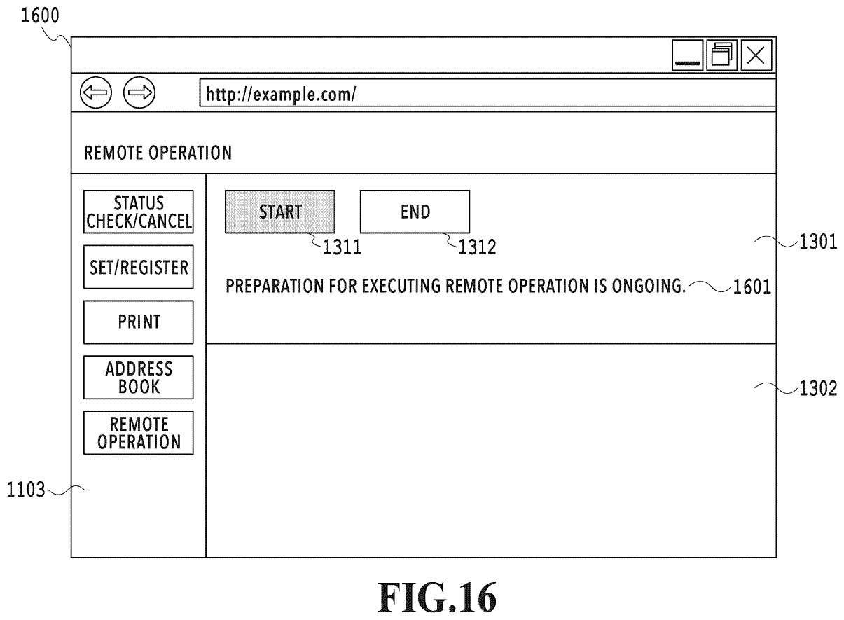

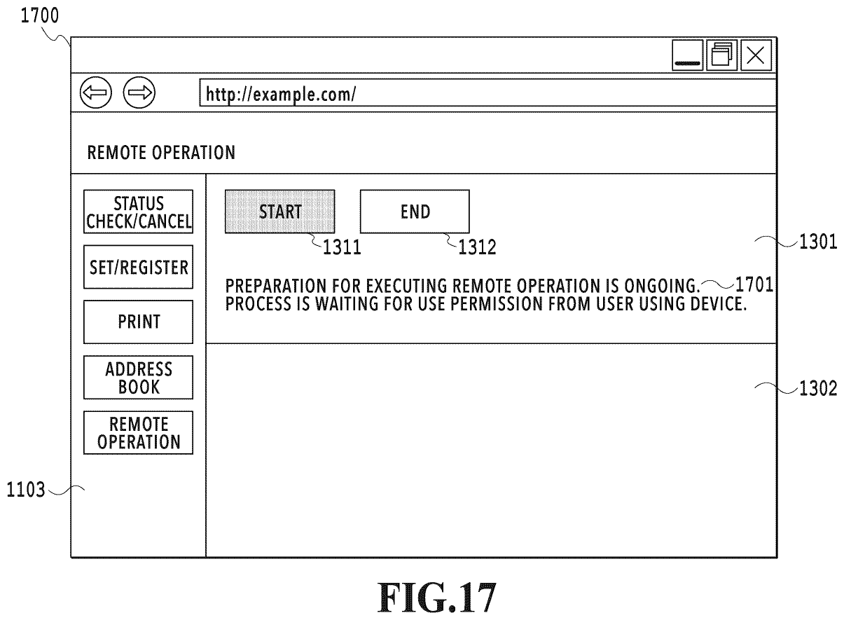

FIGS. 16 and 17 are examples of the remote operation screen displayed in S1503. The messages are updated from those in the remote operation screens illustrated in FIGS. 13 and 14. In the case where the information indicating the login status received in S1207 in the display process of the remote operation screen is “login user absent”, a third remote operation screen 1600 illustrated in FIG. 16 is displayed in the display device 406 of the PC 101. In the case where the information indicating the login status received in S1207 is “login user present”, a fourth remote operation screen 1700 illustrated in FIG. 17 is displayed. The third remote operation screen 1600 and the fourth remote operation screen 1700 are each provided with the menu region 1103, the operation region 1301, and the operation screen display region 1302. Note that, since the start process is executed, the start button 1311 is displayed with its color changed to a color indicating a selected state, and the end button 1312 is displayed with its color restored to a color indicating a not-selected state. A message 1601 is a message expressing the progress status of the remote connection. The message determined in S1503 is displayed in the message 1601. The same screen as the screen displayed in the operation unit 207 is displayed in the operation screen display region 1302. The third remote operation screen 1600 and the fourth remote operation screen 1700 are screens displayed in the case where the remote operation state is “preparation ongoing”, and this state is a state where the start process of the remote operation is not completed yet. Accordingly, nothing is displayed in the operation screen display region 1302.

The message of the row 706 of the message data 610 illustrated in FIG. 7 is displayed as the message 1601 displayed on the third remote operation screen 1600 illustrated in FIG. 16. This is because the remote operation state 701 is “preparation ongoing”, and the device login status 702 is “login user absent”. Specifically, “preparation for executing remote operation is ongoing” is displayed. The remote user referring to this message can recognize that the state of the remote operation is “preparation ongoing” without particular restrictions.

The message of the row 707 of the message data 610 illustrated in FIG. 7 is displayed as a message 1701 displayed on the fourth remote operation screen 1700 illustrated in FIG. 17. This is because the remote operation state 701 is “preparation ongoing”, and the device login status 702 is “login user present”. Specifically, “preparation for executing remote operation is ongoing. Process is standing by for use permission from user using device” is displayed. The remote user referring to this message can recognize that another user is currently logging in the image forming apparatus 102 and using the image forming apparatus 102. Moreover, the remote user can recognize that the process of the remote operation started by the remote user is waiting for the use permission from the other user, and immediate start of the remote operation thus may not be possible. Specifically, this state is a state where a confirmation screen 1800 for permitting or denying the remote connection is displayed in the operation unit 207 of the image forming apparatus 102 in S1504 to be described later, and the process is waiting for the answer from the user logged in and using the image forming apparatus 102. The confirmation screen 1800 for permitting or denying the remote connection is described later.

Returning to explanation of FIG. 15B, the web server 330 of the image forming apparatus 102 is standing by for the request to start the remote operation from the web browser 502 of the PC 101. In S1504, the web server 330 determines whether the start instruction of the remote operation is received from the web browser 502. In the case where the web server 330 receives the HTTP request indicating the start instruction of the remote operation from the web browser 502, the web server 330 determines that the start request of the remote operation is made from the web browser 502 (start instruction of the remote operation is received). In the case where the web server 330 receives the HTTP request transmitted from the web browser 502 in S1501, the web server 330 requests the remote UI control component 331 to perform a process. The remote UI control component 331 obtains information indicating the login status of the user currently logged in the image forming apparatus 102, from the authentication component 311 via the event processing component 307.

In S1505, the remote UI control component 331 determines whether the user currently logged in the image forming apparatus 102 is present or not, based on the information indicating the login status. In the case where the remote UI control component 331 determines that the currently-logged-in user is absent in the result of the determination of S1505, the process proceeds to S1512. In the case where the remote UI control component 331 determines that the logged-in user is present, the process proceeds to S1506.

In S1506, the remote UI control component 331 notifies the event processing component 307 of presence of the currently-logged-in user. Moreover, the remote UI control component 331 displays the confirmation screen 1800 for permitting or denying the remote connection on the operation unit 207, and inquires the currently-logged-in user about whether to permit or deny the remote connection. The display of the confirmation screen 1800 for permitting or denying the remote connection is executed by the CPU 202 of the image forming apparatus 102.

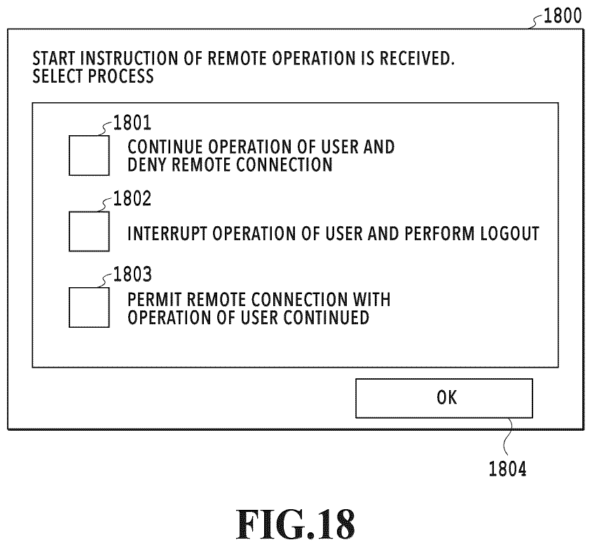

FIG. 18 is a diagram illustrating the confirmation screen 1800 for permitting or denying the remote connection displayed in the operation unit 207 of the image forming apparatus 102. A check box 1801 is selected in the case where the operation of the currently-logged-in user is to be continued and the remote connection by the remote user is to be denied. The remote user is a user who has transmitted the start instruction of the remote operation from the PC 101. A check box 1802 is selected in the case where the operation of the currently-logged-in user is to be interrupted and the currently-logged-in user is to log out. A check box 1803 is selected in the case where the remote connection is to be permitted with the operation of the currently-logged-in user continued. The check box 1803 is selected, for example, in a situation where the currently-logged-in user has trouble operating a screen and receives support of screen operation by sharing the screen with the remote user at a remote location. The check boxes 1801 to 1803 are controlled such that only one of the check boxes 1801 to 1803 can be selected. An OK button 1804 is operated to finalize the setting of the check boxes 1801 to 1803. In the case where the currently-logged-in user selects one of the check boxes 1801 to 1803 and selects the OK button 1804, the remote UI control component 331 closes the confirmation screen 1800, and executes the process selected by the currently-logged-in user.

In S1507, the remote UI control component 331 receives information (answer) on the check box selected the currently-logged-in user.

In S1508, the remote UI control component 331 determines whether the check box selected by the currently-logged-in user is the check box 1801 (the operation of the user is continued and the remote connection is denied) or not. If the remote UI control component 331 determines that the check box 1801 is selected in the result of the determination of S1508, the process proceeds to S1509. If the remote UI control component 331 determines that the check box selected by the currently-logged-in user is not the check box 1801, the process proceeds to S1510.

In S1509, the remote UI control component 331 transmits the connection denial to the web browser 502 via the web server 330, and terminates the process of the flowchart in FIG. 15B.

If the check box 1801 is not selected in the result of the determination of S1508, the remote UI control component 331 causes the process to proceed to S1510.

In S1510, the remote UI control component 331 determines whether the check box selected by the currently-logged-in user is the check box 1802 (the operation of the user is interrupted and the log out is performed) or not. If the remote UI control component 331 determines that the check box 1802 is selected in the result of the determination of S1510, the process proceeds to S1511. If the remote UI control component 331 determines that the check box selected by the currently-logged-in user is not the check box 1802, the process proceeds to S1512.

In S1511, the remote UI control component 331 performs the logout of the user currently logged in the image forming apparatus 102. The remote UI control component 331 executes this process by notifying the authentication component 311 of execution of the logout process via the event processing component 307. The process proceeds to S1512 after execution of the logout process.

In the present embodiment, the case where the check box 1802 is not selected in the result of the determination of S1510 means that the check box 1803 (the operation of the user is continued with the remote connection permitted) is selected. In this case, the process proceeds to S1512.

In S1512, the remote UI control component 331 transmits the information indicating “connection permission” to the web browser 502 via the web server 330.

Next, in S1513, the connection processing component 321 executes a connection process of VNC.

In S1514, the web browser 502 receives information indicating the connection permission or denial and transmitted from the web server 330 in S1509 or S1512, as a response to the HTTP request.

In S1515, the web browser 502 determines whether the information received in S1514 is the connection permission or the connection denial. If the web browser 502 determines that the information indicating “connection permission” is received in the result of the determination in S1514, the process proceeds to S1516. If the web browser 502 determines that the information received in S1514 is the information indicating connection denial in the result of the determination in S1514, the process proceeds to S1522. In S1516, the web browser 502 executes the connection process of VNC.

In the connection process of VNC, the PC 101 and the image forming apparatus 102 exchange information on the connection. Specifically, in S1513 and S1516, the connection processing component 321 of the VNC server 320 executes the connection process of VNC with the web browser 502 of the PC 101 via the web server 330 and the data conversion component 340 of the image forming apparatus 102. Since the connection process of VNC is a publicly known process based on the remote frame buffer (RFB) protocol (RFC 6143), detailed explanation thereof is omitted.

In the case where the connection process of VNC is completed and the VNC connection is established, the screen data of the screen displayed in the operation unit 207 is transmitted from the image forming apparatus 102 to the PC 101. In this process, the screen data may be requested from the PC 101 side or the image forming apparatus 102 may actively transmit the screen data to the PC 101 after the establishment of the VNC connection. In the present embodiment, explanation given by using an example in which the image forming apparatus 102 actively transmits the screen data to the PC 101.

In S1517, the screen transmission component 323 reads the screen data generated by the image generation component 308, from the RAM 203, and transmits the screen data to the web browser 502 via the data conversion component 340 and the web server 330. Thereafter, the process of the flowchart in FIG. 15B is terminated.

Meanwhile, in the PC 101, after the establishment of the VNC connection, in S1518, the web browser 502 updates the remote operation state to “ongoing”, and saves the remote operation state in the RAM 203.

In S1519, the web browser 502 determines the message expressing the progress status of the remote connection based on the remote operation state 701 and the device login status 702, and updates the message to be displayed on the remote operation screen.

In S1520, the web browser 502 receives the screen data of the operation unit 207 transmitted from the image forming apparatus 102 in S1517.

In S1521, the web browser 502 displays the same screen as the screen displayed in the operation unit 207 based on the received screen data, and terminates the process of the flowchart in FIG. 15A.

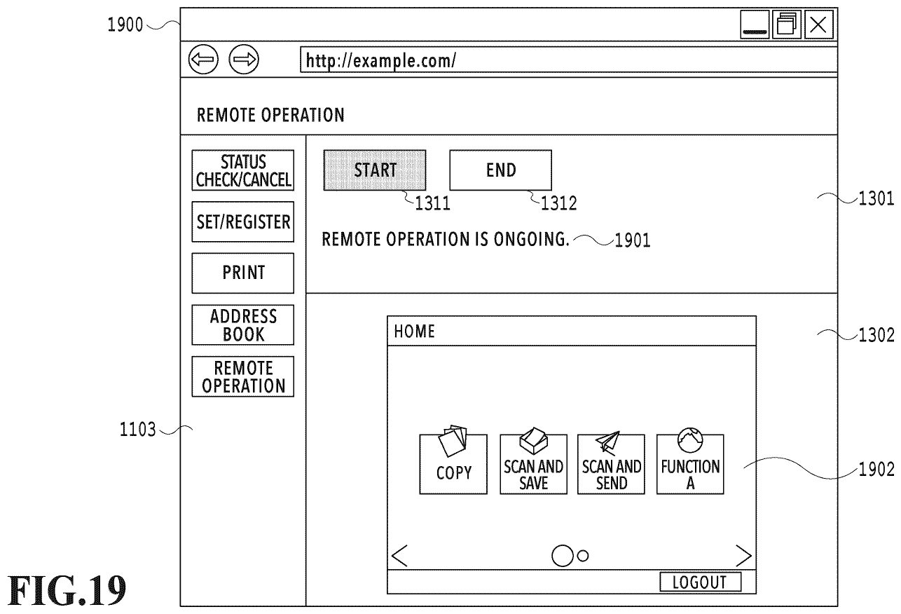

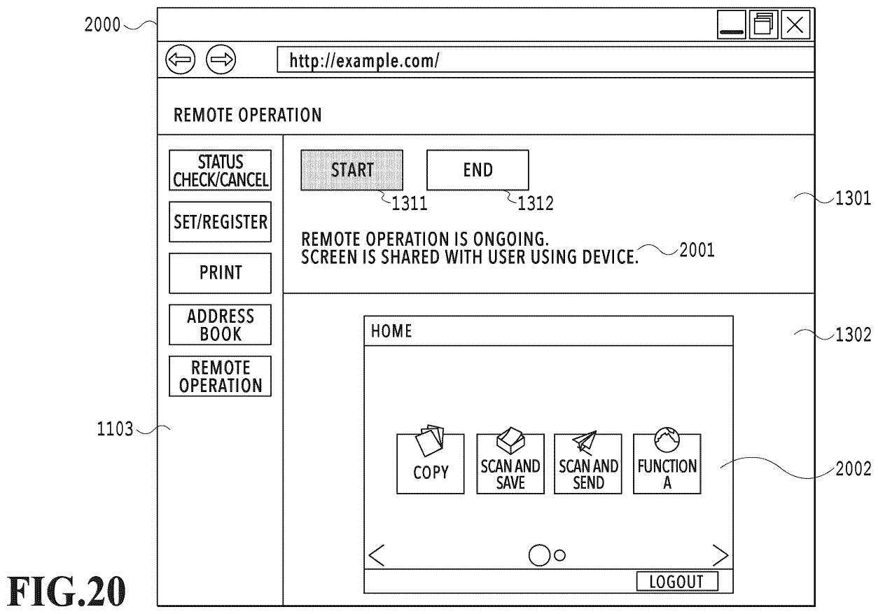

FIGS. 19 and 20 are examples of the remote operation screen displayed in S1521. The message expressing the progress status of the remote connection is updated from that in the remote operation screen illustrated in FIGS. 16 and 17. In the case where the information indicating the login status received in S1207 is “login user absent”, a fifth remote operation screen 1900 illustrated in FIG. 19 is displayed in the display device 406 of the PC 101. In the case where the information indicating the login status received in S1207 is “login user present”, a sixth remote operation screen 2000 illustrated in FIG. 20 is displayed. The fifth remote operation screen 1900 and the sixth remote operation screen 2000 are provided with the menu region 1103, the operation region 1301, and the operation screen display region 1302. A message 1901 is a message expressing the progress status of the remote connection. A message expressing the progress status of the remote connection determined in S1519 is displayed in the message 1901. In the operation screen display region 1302, the same screen as the screen displayed in the operation unit 207 of the image forming apparatus 102 is displayed. The screen is displayed based on the screen data received in S1520. For example, in the case where the screen displayed in the operation unit 207 of the image forming apparatus 102 is the home screen, the same home screen 1902 is displayed also in the operation screen display region 1302. The message of the row 708 of the message data 610 illustrated in FIG. 7 is displayed in the message 1901 displayed on the fifth remote operation screen 1900. This is because the remote operation state 701 is “ongoing”, and the device login status 702 is “login user absent”. Specifically, “remote operation is ongoing” is displayed. The remote user referring to this message can recognize that the remote operation can be executed without particular restrictions.

The row 709 of the message data 610 illustrated in FIG. 7 is displayed in a message 2001 displayed on the sixth remote operation screen 2000 illustrated in FIG. 20. This is because the remote operation state 701 is “ongoing”, and the device login status 702 is “login user present”. Specifically, “remote operation is ongoing. Screen is shared with user using device” is displayed. The remote user referring to this message can recognize that the current remote operation state is “ongoing”. Moreover, since another user is logged in and using the image forming apparatus 102, the same screen as a screen 2002 currently displayed is also displayed in the operation unit 207 of the image forming apparatus 102. The remote user can recognize that the other user logged in and using the image forming apparatus 102 is viewing the same screen 2002.

Returning to explanation of FIG. 15A, in the case where the information indicating connection denial is transmitted from the image forming apparatus 102 in S1515, the process proceeds to S1522. In S1522, the web browser 502 displays an error screen 2100.

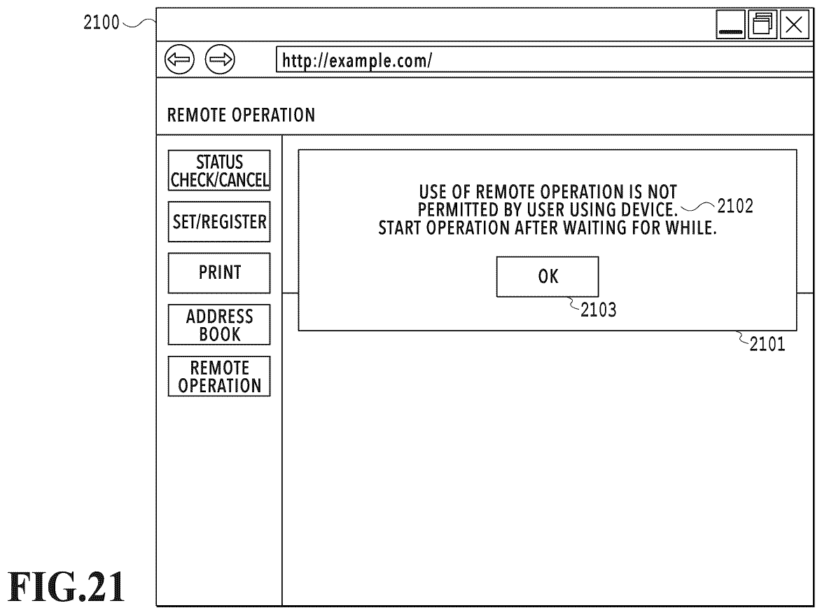

FIG. 21 is an example of the error screen 2100 displayed by the web browser 502 in S1522. As illustrated in FIG. 21, a pop-up screen 2101 including an error message 2102 is displayed on the remote operation screen. In the case where an OK button 2103 is pressed, the pop-up screen 2101 is closed. In the example of FIG. 21, a message such as “use of remote operation is not permitted by user using device. Start operation after waiting for while” is displayed as the error message 2102. The screen data of the pop-up screen 2101 is stored in advance in the HDD 404.

Next, in S1523, the web browser 502 updates the remote operation state to “before start”, and saves the remote operation state in the RAM 203. In S1524, the web browser 502 determines the message 703 expressing the progress status of the remote connection based on the remote operation state 701 and the device login status 702. The web browser 502 updates the message to be displayed on the remote operation screen to the determined message, and terminates the process of the flowchart in FIG. 15A. The remote operation state 701 at this stage is “before start”. In the case where the device login status is “login user absent”, the web browser 502 updates the screen to be displayed to the first remote operation screen 1300 illustrated in FIG. 13. In the case where the device login status 702 is the “login user present”, the web browser 502 updates the screen to be displayed to the second remote operation screen 1400 illustrated in FIG. 14.

The PC 101 and the image forming apparatus 102 exchange information such as the display screen based on the RFB protocol from here on. Specifically, the web browser 502 of the PC 101 transmits information on operations performed by the user on the remote operation screen displayed in the display device 406, to the web server 330 of the image forming apparatus 102. Since this information on operations is data relating to the VNC operation on the remote operation screen, the web server 330 requests the operation information receiving component 322 to perform a process via the data conversion component 340. Moreover, the screen transmission component 323 transmits the screen information to the web server 330 via the data conversion component 340. The web server 330 transmits the received screen information to the web browser 502. The web browser 502 displays the received screen information on the display device 406. As described above, the remote user can remotely operate the image forming apparatus 102 from the PC 101 as in the case of operating the operation unit 207 of the image forming apparatus 102.

Note that, in S1506, the CPU 202 may cause a clock component to measure a time period in the case where the confirmation screen 1800 (FIG. 18) for permitting or denying the remote connection is displayed in the operation unit 207 of the image forming apparatus 102. The clock component is assumed to be included in the system software 301. In the case where no answer (selection information of the check box) made by the user is received after elapse of a predetermined time period from start of the display of the confirmation screen 1800, the connection processing component 321 closes the confirmation screen 1800. Moreover, the connection processing component 321 executes the same process as the process in the case where one of the check boxes 1801 to 1803 is selected. For example, the connection processing component 321 performs the logout of the user currently logged in the image forming apparatus 102 (corresponding to S1511), and then executes the processes of S1512 and beyond as in the case where the check box 1802 is selected. This can reduce the waiting time of the user operating the PC 101. Specifically, a period in which the confirmation screen 1800 for permitting or denying the remote connection is displayed in the image forming apparatus 102 is a state where the process is waiting for the response to the start instruction of the remote operation in S1503 (“preparation ongoing”) from the perspective of the user operating the PC 101. Accordingly, providing the time-out process as described above allows the waiting time of the remote user to end and cause the start process of the remote operation to proceed.

### User Authentication Process

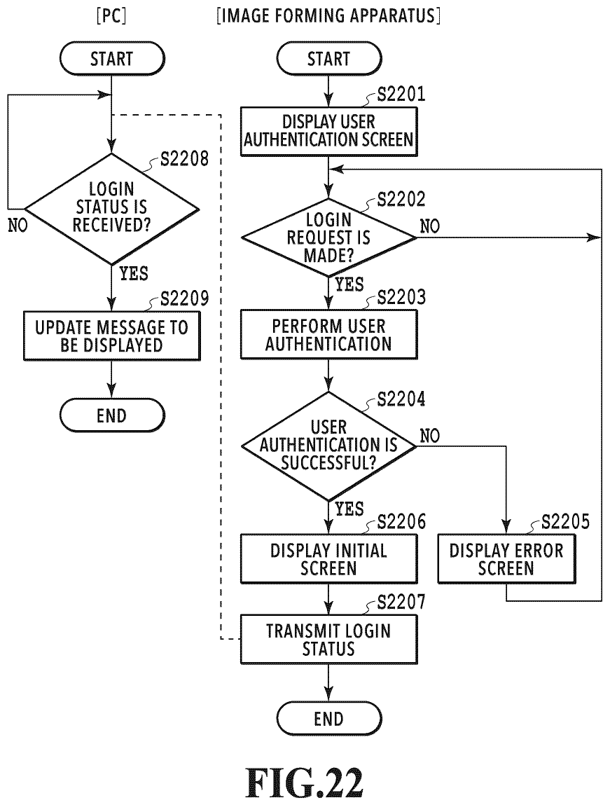

Next, details of processes executed by the information processing system 100 in the case where the user using the image forming apparatus 102 performs the user authentication (login or logout) in the image forming apparatus 102 are explained with reference to FIGS. 22 to 25.

### Login Process

FIG. 22 is a flowchart illustrating a flow of a login process executed in the information processing system 100. The left portion of FIG. 22 is a flowchart explaining a process executed by the CPU 401 of the PC 101. The right portion of FIG. 22 is a flowchart explaining a process executed by the CPU 202 of the image forming apparatus 102. The present flowchart is started based on start of the login process in which the user operates the operation unit 207 of the image forming apparatus 102 and logs into the image forming apparatus 102. Note that setting is assumed to be such that the user authentication is performed in the image forming apparatus 102.

After the activation of the image forming apparatus 102, in S2201, the authentication component 311 transmits an event of displaying a login screen, to the event processing component 307, and displays the login screen in the operation unit 207.

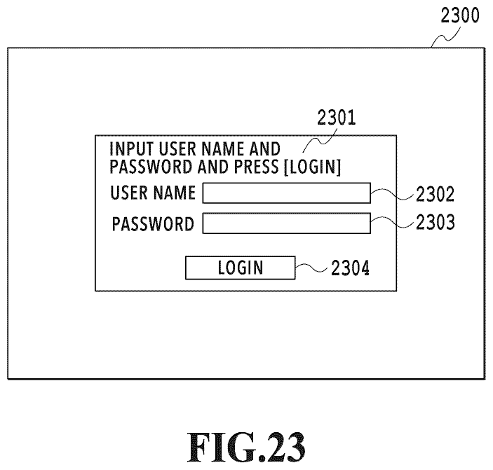

FIG. 23 is an example of a login screen 2300. The login screen 2300 is provided with a message 2301 requesting information input by the user such as “input user name and password, and press [login]”, a user name input field 2302, and a password input field 2303. Moreover, the login screen 2300 is provided with a login button 2304 that is operated in the case where the login is performed. In the case where the user of the image forming apparatus 102 inputs the user name and the password into the user name input field 2302 and the password input field 2303, respectively, and the login button 2304 is pressed, the authentication component 311 starts the login process.

In S2202, the event processing component 307 stands by for reception of a login request. In the case where the user presses the login button 2304 on the login screen 2300, the event processing component 307 determines that the login request is made. If the event processing component 307 determines that the login request is made, the process proceeds to S2203. If the event processing component 307 determines that the login request is not made, the event processing component 307 repeats the process of S2202.

In S2203, the event processing component 307 receives a login event based on the login request from the operation input analysis component 305. The event processing component 307 notifies the authentication component 311 of the user name and the password inputted by the user. The authentication component 311 performs the user authentication. A user information list indicating information on users who can use the image forming apparatus 102 is assumed to be registered in advance by the administrator of the image forming apparatus 102 in the HDD 205 of the image forming apparatus 102 or a not-illustrated authentication server. The authentication component 311 checks whether the user information matching the received user name and the password is registered in the user information list or not. If the authentication component 311 determines that the matching user information is present, the user authentication is successful. If the authentication component 311 determines that the matching user information is absent, the user authentication fails. The authentication component 311 sends back a result of the user authentication to the event processing component 307.

In S2204, the event processing component 307 determines whether the user authentication is successful or not. If the event processing component 307 determines that the user authentication is successful in the result of the determination of S2204, the process proceeds to S2206. If the event processing component 307 determines that the user authentication is not successful, the process proceeds to S2205.

In S2205, the image generation component 308 generates a not-illustrated error screen, the screen display component 309 displays the error screen in the operation unit 207, and returns to login request waiting S2202. In the case where the user authentication is successful in the result of the determination of S2204, the process proceeds to S2206.

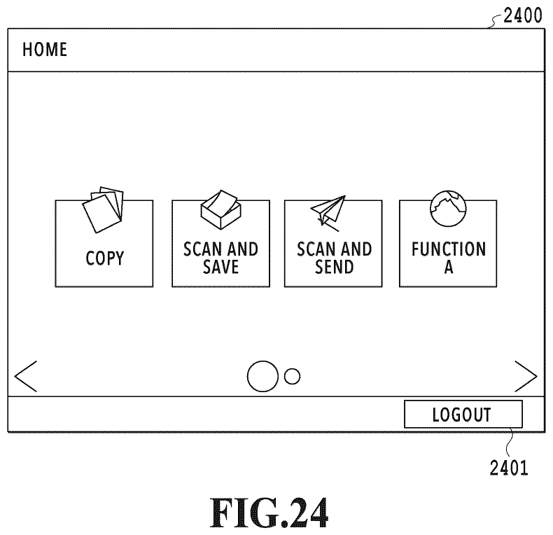

In S2206, the image generation component 308 generates an initial screen, and the screen display component 309 displays the initial screen in the operation unit 207. In the case where, for example, the home screen is set as the initial screen, for example, a home screen 2400 illustrated in FIG. 24 is displayed in the operation unit 207.

In S2207, the event processing component 307 transmits information indicating the login status of the image forming apparatus 102 to the web browser 502, via the remote UI control component 331 and the web server 330, and terminates the process of the flowchart in the right portion of FIG. 22. The information indicating the login status includes information on presence of absence of the logged-in user. If the logged-in user is present, “login user present” is transmitted to the PC 101 as the information indicating the login status. Note that the information indicating the login status is not limited to this, and may include, for example, the user name, the time and date of the login by the user, the time period of login, and the like.

In S2208, the web browser 502 of the PC 101 stands by for reception of the information indicating the login status transmitted from the web server 330 in S2207. If the web browser 502 determines that the information indicating the login status is received, the process proceeds to S2209. If the web browser 502 determines that the information indicating the login status is not received in S2208, the web browser 502 repeats the process of S2208.

In S2209, the web browser 502 determines the message 703 expressing the progress status of the remote connection based on the remote operation state 701 and the device login status 702. Then, the web browser 502 updates the message to be displayed on the remote UI screen or the remote operation screen, and terminates the process of the flowchart in the left portion of FIG. 22.

In the case where the web browser 502 receives the information indicating the login status indicating “login user present” in S2208 in a state where the first remote operation screen 1300 is displayed, the web browser 502 updates the screen to be displayed to the second remote operation screen 1400. The state where the first remote operation screen 1300 is displayed is specifically the state where the remote operation state 701 is “before start” and the device login status 702 is “login user absent”. Moreover, in the case where the web browser 502 receives the information indicating the login status indicating “login user present” in S2208 in a state where the third remote operation screen 1600 is displayed, the web browser 502 updates the screen to be displayed to the fourth remote operation screen 1700. The state where the third remote operation screen 1600 is displayed is specifically the state where the remote operation state 701 is “preparation ongoing” and the device login status 702 is “login user absent”. Furthermore, in the case where the web browser 502 receives the information indicating the login status indicating “login user present” in S2208 in a state where the fifth remote operation screen 1900 is displayed, the web browser 502 updates the screen to be displayed to the sixth remote operation screen 2000. The state where the fifth remote operation screen 1900 is displayed is specifically the state where the remote operation state 701 is “ongoing” and the device login status 702 is “login user absent”.

### Logout Process

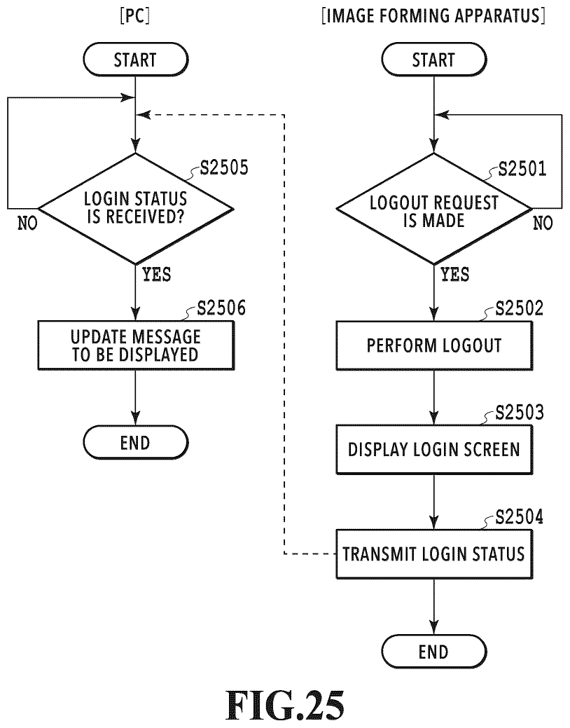

FIG. 25 is a flowchart illustrating a flow of the logout process executed in the information processing system 100. The left portion of FIG. 25 is a flowchart explaining a process executed by the CPU 401 of the PC 101. The right portion of FIG. 25 is a flowchart explaining a process executed by the CPU 202 of the image forming apparatus 102. The present flowchart is started based on start of the logout process in which the user operates the operation unit 207 of the image forming apparatus 102 and logs out from the image forming apparatus 102.

In S2501, the event processing component 307 stands by for reception of the logout request, and determines whether the logout request is made. For example, in the case where the user presses a logout button 2401 displayed on the home screen 2400, the event processing component 307 determines that a logout event based on the logout request is received from the operation input analysis component 305. If the event processing component 307 determines that the logout request is made in S2501, the process proceeds to S2502. If the event processing component 307 determines that the logout request is not made, the event processing component 307 repeats the process of S2501.

In S2502, the event processing component 307 notifies the authentication component 311 of the logout event, and the authentication component 311 executes the logout process.

In S2503, the image generation component 308 generates the login screen 2300, and the screen display component 309 displays the login screen 2300 in the operation unit 207.

In S2504, the event processing component 307 transmits information indicating the login status to the web browser 502 via the remote UI control component 331 and the web server 330, and terminates the process of the flowchart in the right portion of FIG. 25. The information indicating the login status includes the information on presence or absence of the logged-in user. Since the user has logged out in FIG. 24, the information of “login user absent” is transmitted to the PC 101 as the information indicating the login status. Note that the authentication information is not limited to this, and may include the information on, for example, the time and date of logout by the user and the time period of login.

In S2505, the web browser 502 of the PC 101 stands by for reception of the information indicating the login status transmitted from the web server 330 in S2504. In the case where the web browser 502 receives the information indicating the login status, the process proceeds to S2506.

In S2506, the web browser 502 of the PC 101 determines the message 703 expressing the progress status of the remote connection based on the remote operation state 701 and the device login status 702. Then, the web browser 502 updates the message to be displayed on the remote UI screen or the remote operation screen, and terminates the process of the flowchart in the left portion of FIG. 25.

In the case where the web browser 502 receives the information indicating the login state indicating “login user absent” in S2506 in a state where the second remote operation screen 1400 is displayed, the web browser 502 updates the screen to be displayed to the first remote operation screen 1300. The state where the second remote operation screen 1400 is displayed is specifically the state where the remote operation state 701 is “before start” and the device login status 702 is “login user present”. Moreover, in the case where the web browser 502 receives the information indicating the login status indicating “login user absent” in S2506 in a state where the fourth remote operation screen 1700 is displayed, the web browser 502 updates the screen to be displayed to the third remote operation screen 1600. The state where the fourth remote operation screen 1700 is displayed is specifically the state where the remote operation state 701 is “preparation ongoing” and the device login status 702 is “login user present”. Furthermore, in the case where the web browser 502 receives the information indicating the login status indicating “login user absent” in S2506 in a state where the sixth remote operation screen 2000 is displayed, the web browser 502 updates the screen to be displayed to the fifth remote operation screen 1900. The state where the sixth remote operation screen 2000 is displayed is specifically the state where the remote operation state 701 is “ongoing” and the device login status 702 is “login user present”.

As described above, in the case where the user using the image forming apparatus 102 performs the user authentication (login or logout) in the image forming apparatus 102 and the login status changes, the web browser 502 changes the message expressing the progress status of the remote connection and displays the message. This allows the user referring to the message to check the progress status of the remote connection that changes depending on presence or absence of the login user.

### Termination Process of Remote Operation

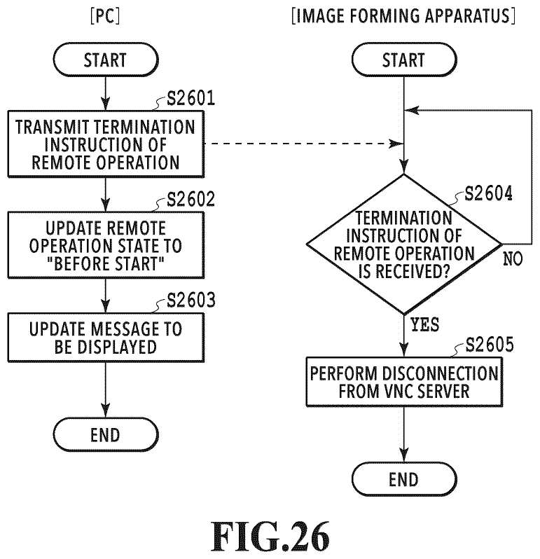

Next, a termination process of the remote operation is explained with reference to FIG. 26.

FIG. 26 is a flowchart illustrating a flow of the termination process of the remote operation executed in the information processing system 100. The left portion of FIG. 26 is a flowchart explaining a process executed by the CPU 401 of the PC 101. The right portion of FIG. 26 is a flowchart explaining a process executed by the CPU 202 of the image forming apparatus 102. The present flowchart is started in the case where the user inputs an instruction to terminate the remote operation. In the present embodiment, the instruction to terminate the remote operation is inputted by a user operation on the end button 1312 displayed in the first to sixth remote operation screens.

In S2601, in the case where the web browser 502 of the PC 101 detects pressing of the end button 1312, the web browser 502 transmits an HTTP request indicating the termination instruction of the remote operation, to the web server 330.

In S2602, the web browser 502 updates the remote operation state to “before start”, and saves the remote operation state in the RAM 203.

In S2603, the web browser 502 determines the message expressing the progress status of the remote connection based on the remote operation state 701 and the device login status 702, updates the message to be displayed on the screen, and terminates the process of the flowchart in the left portion of FIG. 26.

If the termination instruction of the remote operation is inputted in the state where the remote operation state 701 is “before start” and if the device login status 702 is “login user absent”, the first remote operation screen 1300 illustrated in FIG. 13 is displayed. If the termination instruction of the remote operation is inputted in the state where the remote operation state 701 is “before start” and if the device login status 702 is “login user present”, the second remote operation screen 1400 illustrated in FIG. 14 is displayed. The contents of the message displayed in each screen and expressing the progress status of the remote connection are as described above.

If the termination instruction of the remote operation is inputted in the state where the remote operation state 701 is “preparation ongoing” and if the device login status 702 is “login user absent”, the third remote operation screen 1600 illustrated in FIG. 16 is displayed. If the termination instruction of the remote operation is inputted in the state where the remote operation state 701 is “preparation ongoing” and if the device login status 702 is “login user present”, the fourth remote operation screen 1700 illustrated in FIG. 17 is displayed. The contents of the message displayed in each screen and expressing the progress status of the remote connection are as described above.

If the termination instruction of the remote operation is inputted in the state where the remote operation state 701 is “ongoing” and if the device login status 702 is “login user absent”, the fifth remote operation screen 1900 illustrated in FIG. 19 is displayed. If the termination instruction of the remote operation is inputted in the state where the remote operation state 701 is “ongoing” and if the device login status 702 is “login user present”, the sixth remote operation screen 2000 illustrated in FIG. 20 is displayed. The contents of the message displayed in each screen and expressing the progress status of the remote connection are as described above.

In S2604, the web server 330 stands by for an HTTP request from the web browser 502, and determines whether the termination instruction of the remote operation is received. If the web server 330 determines that the termination instruction of the remote operation is received in S2604, the process proceeds to S2605. If the web server 330 determines that the termination instruction of the remote operation is not received, the web server 330 repeats the process of S2604. In the case where the web server 330 receives the HTTP request indicating the termination instruction of the remote operation from the web browser 502, the web server 330 requests the remote UI control component 331 to perform a disconnection process of the VNC connection.

In S2605, the remote UI control component 331 notifies the connection processing component 321 of the disconnection of the VNC connection via the event processing component 307. The connection processing component 321 performs the disconnection of the VNC connection, and terminates the process of the flowchart in the right portion of FIG. 26.

As explained above, in the information processing system 100, the image forming apparatus 102 is configured to be capable of being remotely operated from the PC 101. The PC 101 displays the message corresponding to the remote operation state such as “before start”, “preparation ongoing”, and “ongoing”, in the display device 406 as the notification information expressing the progress status of the remote connection. Accordingly, the remote user can check the progress status of the remote connection on the screen of the PC 101. Moreover, in the present embodiment, the PC 101 displays the message 703 corresponding to the remote operation state 701 and the use status (login status 702) of the image forming apparatus 102, in the display device 406 of the PC 101. This allows the remote user to check not only the remote operation state but also whether another user is using the image forming apparatus 102 or not in the case where the remote user checks the progress status of the remote connection on the screen of the PC 101. In a conventional technique, the remote user operates the image forming apparatus 102 while being unable to grasp the use status of the image forming apparatus 102 by another user. Particularly, the remote user cannot estimate how much time is required for establishment of the remote connection from transmission of the start instruction of the remote operation. In the present embodiment, since various messages are displayed on the PC 101 side depending on the use status such as whether the image forming apparatus 102 is used by another user or not, the use status of the image forming apparatus 102 at a remote location is visualized. Accordingly, the remote user can grasp the progress status of the remote connection in further detail. The operability of the remote operation is thereby improved.

Note that, in the above-mentioned embodiment, notification is performed for all three states of “before start”, “preparation ongoing”, and “ongoing” as the remote operation state. However, the present disclosure is not limited to this example, and notification may be performed for one or two of the three states.

### Modified Example 1

In the above-mentioned embodiment, the web browser 502 displays the message expressing the progress status of the remote connection, on the screen for giving the instruction of starting or terminating the remote operation. The screen for giving the instruction of starting or terminating the remote operation is, for example, the first remote operation screen 1300 or the second remote operation screen 1400. However, the present disclosure is not limited to this procedure. The message expressing the progress status of the remote connection may be displayed on the top screen of the remote UI.

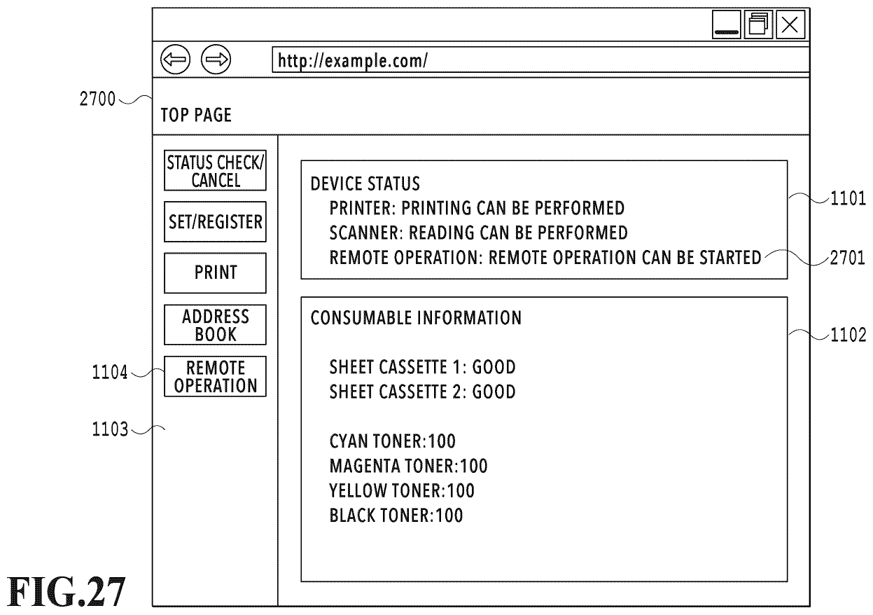

FIG. 27 is a diagram illustrating an example of a second top screen 2700 of the remote UI displayed in the modified example 1. Explanation is given of points where the second top screen 2700 illustrated in FIG. 27 is different from the top screen 1100 illustrated in FIG. 11.

A message 2701 expressing the progress status of the remote connection is displayed on the second top screen 2700 in addition to the display information in the top screen 1100 illustrated in FIG. 11. In the example of FIG. 27, the contents of the message 2701 are “remote operation can be started”. Specifically, FIG. 27 illustrates the case where the remote operation state 701 is “before start” and the device login status 702 is “login user absent”. Displaying the message expressing the progress status of the remote connection as described above on the remote UI screen allows display of the first remote operation screen 1300 or the second remote operation screen 1400 to be skipped.

Specifically, in the display process (FIG. 10) of the remote UI screen, the web server 330 of the image forming apparatus 102 obtains the login status in the image forming apparatus 102 from the authentication component 311 before S1003. Then, in S1003, the web server 330 transmits the obtained information (second information) indicating the login status to the web browser 502, together with the screen data of the top screen of the remote UI. In S1004, the web browser 502 receives the information indicating the login status of the image forming apparatus 102 and the screen data of the top screen of the remote UI. In S1005, the web server 330 determines the contents of the message to be displayed on the top screen based on the remote operation state and the received information indicating the login status, forms the second top screen 2700 based on the screen data, and displays the screen data in the display device 406.

Alternatively, before S1003, the web server 330 of the image forming apparatus 102 obtains the login status in the image forming apparatus 102 from the authentication component 311, and determines the message corresponding the login status and the remote operation state. Then, in S1003, the web server 330 may perform a procedure of transmitting the screen data of the second top screen 2700 including the determined message, to the web browser 502. The contents of the message may be determined from the message data 610 based on the remote operation state and the device login status, as in the above-mentioned embodiment.

In the case where the remote operation state 701 is “before start” and the device login status 702 is “login user present”, the message “remote operation can be started. Currently, another user is using device. Process will wait for use permission from user using device in case where remote operation is started” illustrated in the row 705 of the message data 610 in FIG. 7 is displayed on the second top screen 2700. In the case where the remote user selects the link button 1104 to the remote operation on the second top screen 2700, the start process of the remote operation illustrated in FIGS. 15A and 15B is executed.

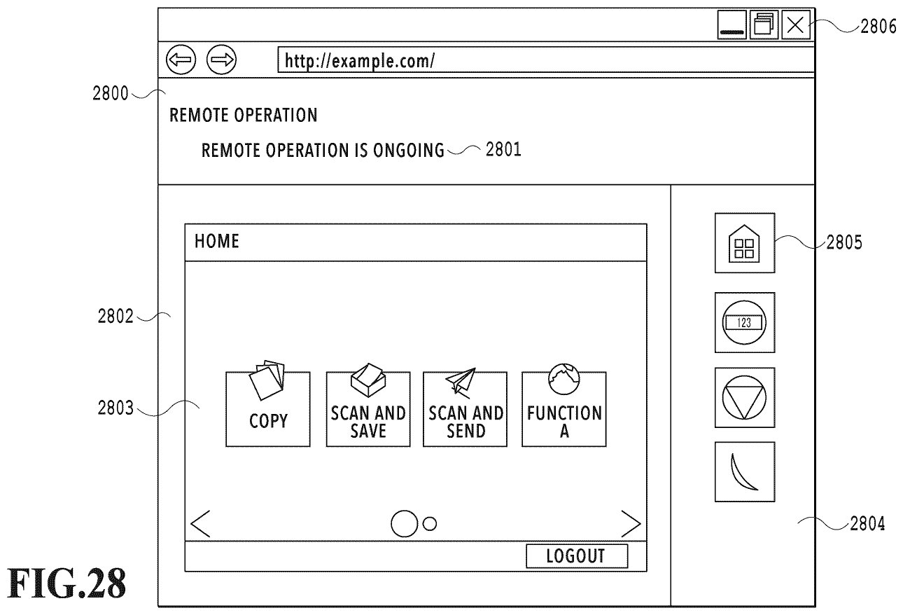

FIG. 28 is a diagram illustrating an example of a remote operation screen 2800 in the modified example 1. The remote operation screen 2800 in the modified example 1 illustrates the case where the remote operation state is “ongoing” and the device login status is “login user absent”. The remote operation screen 2800 in the modified example may be displayed by updating the display of the second top screen 2700 or displayed in another tab or another window. An operation screen 2803 that is the same as the screen displayed in the operation unit 207 of the image forming apparatus 102 is displayed in an operation screen display region 2802 of the remote operation screen 2800 in the modified example 1, and can be operated from the PC 101. Moreover, hard key buttons 2805 having the same functions as the hard keys provided in the operation unit 207 of the image forming apparatus 102 is displayed in a region 2804, and can be operated from the PC 101. For example, the hard key buttons 2805 include a button for transition to the home screen, a button for transition to a counter/device information screen, a button for stopping an operation currently executed in the image forming apparatus 102, a button for performing transition to and resume from power saving of the image forming apparatus 102, and the like.

The remote operation screen 2800 illustrated in FIG. 28 is a screen displayed in the case where the remote operation state is “ongoing”. Accordingly, the start button 1311 and the end button 1312 displayed in each remote operation screen illustrated in the first embodiment are not displayed. In the case where the remote operation is to be terminated, a “×” button 2806 for closing the screen may be used.

A message 2801 is a message expressing the progress status of the remote connection. The web browser determines the message 2801 to be displayed from the message data 610, depending on the remote operation state 701 and the device login status 702, and displays the message 2801 on the remote operation screen 2800. In the case where the remote operation state 701 or the device login status 702 changes, the web browser 502 updates the contents of the message to be displayed, depending on the remote operation state 701 and the device login status 702 after the change.

As explained above, according to the modified example 1, the PC 101 displays the message expressing the progress status of the remote connection, on the top screen of the remote UI. Then, the remote operation is started directly from the remote UI screen with the screen (first remote operation screen 1300 or second remote operation screen 1400) instructing start of the remote operation skipped. Accordingly, an operation can be simplified. The remote user can grasp the use status of the image forming apparatus 102 by another user, on the top screen of the remote UI. Accordingly, the operability of the remote operation is improved.

### Modified Example 2

In the first embodiment, the message that expresses the progress status of the remote connection and that corresponds to the remote operation state and the use status of the image forming apparatus 102 is displayed in the web browser 502 of the PC 101. However, the present disclosure is not limited to this example, and only the state of the remote operation may be displayed as a message expressing the progress status of the remote connection, irrespective of the use status of the image forming apparatus 102. Specifically, in the case where the remote operation status is “before start”, the web browser 502 displays only the message “remote operation can be started” illustrated in the row 704 of the message data illustrated in FIG. 7. Alternatively, the web browser 502 may only perform status display indicating that the remote operation state is “before start”. Similarly, in the case where the remote operation state is “preparation ongoing”, the web browser 502 may display “preparation for executing remote operation is ongoing” illustrated in the row 706 of the message data illustrated in FIG. 7, irrespective of the use status of the image forming apparatus 102. Alternatively, the web browser 502 may only perform status display indicating “preparation ongoing”. Moreover, in the case where the remote operation state is “ongoing”, the web browser 502 may display “remote operation is ongoing” illustrated in the row 708 of the message data illustrated in FIG. 7, irrespective of the use status of the image forming apparatus 102. Alternatively, the web browser 502 may only perform status display indicating “ongoing”.

In the information processing system 100 illustrated in a modified example 2, the PC 101 can access the VNC server 320 of the image forming apparatus 102 via the web browser 502, and execute the remote operation. Then, the web browser 502 obtains the state of the remote operation between the PC 101 and the image forming apparatus 102. As explained in the first embodiment, the remote operation state is determined based on whether the start instruction of the remote operation is transmitted or not in the remote operation request transmission unit 604 and the information indicating permission or denial of the connection obtained from the connection processing component 321 of the VNC server 320. The web browser 502 determines the message corresponding to the remote operation state, from the message data 610 depending on the remote operation state, and displays the message on the remote operation screen or the remote UI screen as the message expressing the progress status of the remote connection. Alternatively, the web browser 502 performs status display corresponding to the remote operation state as the progress status of the remote connection.

As described above, the remote operation state includes “before start”, “preparation ongoing”, and “ongoing”. Moreover, the web browser 502 performs the message notification or the status display before the remote user performs the operation of the start instruction of the remote operation. Furthermore, in the case where the remote operation state is changed, the web browser 502 updates the contents of the notification message or the status display depending on the remote operation state after the change.

The PC 101 can thereby execute the remote operation of the image forming apparatus 102 via the web browser 502, and in this remote operation, the remote user can check at least the remote operation state (status) on the screen of the PC 101. Accordingly, the progress status of the remote connection can be displayed via the web browser 502 in a simple manner.

### Modified Example 3

The message expressing the progress status of the remote connection may have contents applicable to both of the case where the login status of the image forming apparatus 102 is “login user present” and the case where the login status is “login user absent”, irrespective of the actual use status of the image forming apparatus 102. Specifically, in the case where the remote operation state is “before start” or “preparation ongoing”, the web browser 502 may display, for example, a general-purpose message such as “remote connection may take time depending on use status of device” irrespective of the use status of the image forming apparatus 102. This message may be displayed on the remote operation screen on which the user can give the instruction of starting the remote operation as illustrated in the first embodiment, or displayed on the top screen of the remote UI as illustrated in the modified example 1. Moreover, the web browser 502 may perform status display expressing the remote operation state of “before start” or “preparation ongoing”, together with display of the above-mentioned general-purpose message. Furthermore, in the case where the remote operation state is “ongoing”, the web browser 502 may display a message such as “in case where user using device is present, screen is shared” as the general-purpose message. Moreover, the web browser 502 may perform status display of “ongoing” together with display of the general-purpose message.

In the modified example 3, display suggesting a situation where the user using the image forming apparatus 102 is present can be performed in the PC 101 irrespective of the login status of the image forming apparatus 102. Accordingly, in the case where time standing by for connection from the input of the start instruction of the remote operation by the remote user is long, the remote user can infer that another user is using the image forming apparatus 102.

Note that, in the first embodiment and the modified examples thereof, the PC 101 determines the message to be displayed on the PC 101 side by obtaining the information indicating the login status of the image forming apparatus 102 with the web browser 502. The PC 101 obtains the information with the web browser 502 because the RFB protocol used by the VNC server 320 does not support exchange of the login status of the image forming apparatus 102 and exchange of character strings to be displayed on the PC 101 side. However, display of the message expressing the progress status of the remote connection and update of this display as described above can be performed without use of the web browser 502. In this case, the CPU 401 of the PC 101 executes a process according to an application program that performs various processes relating to the remote operation explained in the first embodiment. The application program is assumed have the same functions as the obtaining unit 601, the determination unit 602, the notification unit 603, and the remote operation request transmission unit 604 (FIG. 6) illustrated in FIG. 6. In this case, the obtaining unit 601 obtains the information indicating the login status of the image forming apparatus 102 and the information indicating permission or denial of the remote operation by using an expanded protocol obtained by expanding the RFB protocol. Alternatively, the obtaining unit 601 obtains the information indicating the login status of the image forming apparatus 102 and the information indicating permission or denial of the remote operation by using a network communication method (for example, management information base (MIB)) other than the RFB protocol.

### Second Embodiment

Although the contents of the message expressing the progress status of the remote connection to be displayed in the PC 101 are determined on the PC 101 side in the first embodiment, the contents may be determined on the image forming apparatus 102 side. In the second embodiment, explanation is given of the case where an image forming apparatus 102A of a second embodiment determines the contents of the message, and causes a PC 101A of the second embodiment to display the contents. Note that, in the second embodiment, the information processing system, the PC, and the image forming apparatus are assumed to be denoted by reference signs of 100A, 101A, and 102A, respectively. Since a system configuration of the information processing system 100A and hardware configurations and software configurations of the PC 101A and the image forming apparatus 102A are the same as those of the first embodiment illustrated in FIGS. 1 to 5, explanation thereof is omitted. In the following explanation, the same parts as those in the first embodiment are explained while being denoted by the same reference signs.

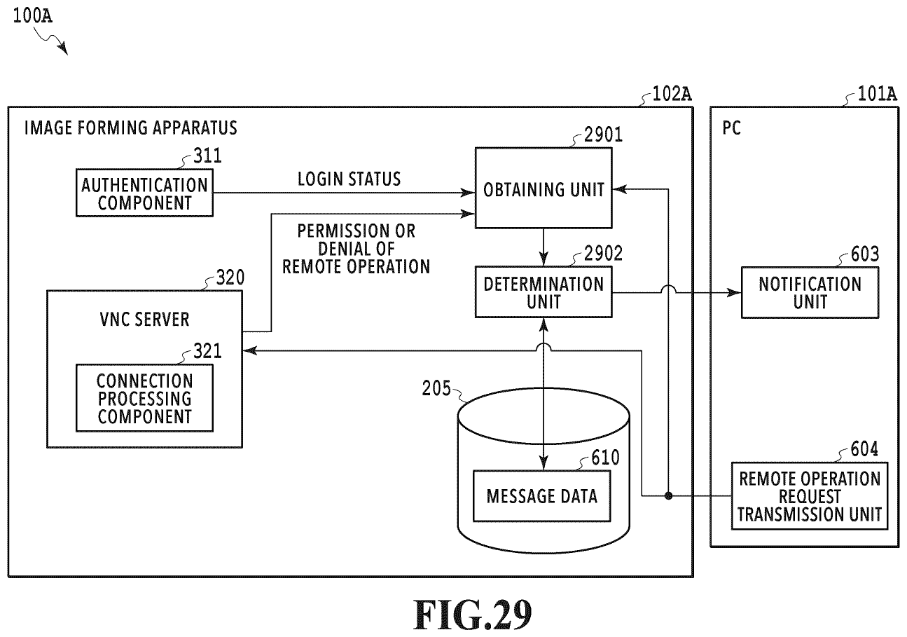

FIG. 29 is a diagram illustrating a functional configuration of the information processing system 100A according to the second embodiment. As illustrated in FIG. 29, in the information processing system 100A according to the second embodiment, the image forming apparatus 102A of the second embodiment includes an obtaining unit 2901, a determination unit 2902, the authentication component 311, the VNC server 320, and the like. Moreover, multiple pieces of message data 610 are stored in the HDD 404 of the image forming apparatus 102A. The message data 610 includes the candidates of messages expressing the progress status of the remote connection as in the first embodiment. The PC 101A of the second embodiment includes the notification unit 603, the remote operation request transmission unit 604, and the like. Also in the second embodiment, as in the first embodiment, the image forming apparatus 102A functions as the web server 330 and the VNC server 320. Moreover, the image forming apparatus 102A exchanges the screen data, a state of the image forming apparatus 102A, the setting data, the use status (login status), and other pieces of data with the web browser 502 of the PC 101A. Moreover, data relating to the remote operation is exchanged by connection with the VNC server 320 of the image forming apparatus 102A via the web browser 502 of the PC 101A and the web server 330 of the image forming apparatus 102A. The RFB protocol (RFC 6143) is used for communication between the VNC server and the client. The HTTP protocol is used for communication between the web browser 502 and the web server 330.

The obtaining unit 2901 obtains the first information indicating the state of the remote operation between the PC 101A and the image forming apparatus 102A and the second information indicating the use status of the image forming apparatus 102A. The first information is determined based on whether the start instruction of the remote operation is transmitted from the PC 101A to the image forming apparatus 102A or not or the response (connection permitted/connection denied) to the start instruction of the remote operation from the image forming apparatus 102A. The start instruction of the remote operation and the response to the start instruction are exchanged between the remote operation request transmission unit 604 and the VNC server 320 via the web browser 502 of the PC 101A in the present embodiment.

The remote operation state indicated by the first information is one of “before start”, “preparation ongoing”, and “ongoing” as in the first embodiment. “Before start” is a state before execution of the operation of the start instruction of the remote operation in the PC 101A or a state where the response to the effect that the remote connection is denied is determined in the image forming apparatus 102A. “Preparation ongoing” is a state after execution of the operation of the start instruction of the remote operation in the PC 101A by the user and reception of the start instruction of the remote operation from the remote operation request transmission unit 604 and before determination of the response indicating permission or non-permission of the remote operation by the image forming apparatus 102A. “Ongoing” is a state where the remote connection is established as a result of the start instruction of the remote operation and the response and the remote operation is executable.

The use status of the image forming apparatus 102A indicated by the second information is the same as that in the first embodiment, and is information indicating whether a user logged in the image forming apparatus 102A is present or not. In the case where a user logged in the image forming apparatus 102A is present, that is a user using the image forming apparatus 102A is present, the second information is “login user present”. In the case where a user logged in the image forming apparatus 102A is absent, that is a user using the image forming apparatus 102A is absent, the second information is “login user absent”. The second information is transmitted from the authentication component 311 to the obtaining unit 2901 of the image forming apparatus 102A.

The determination unit 2902 determines the notification information which the user of the PC 101A is to be notified of, based on the first information and the second information obtained by the obtaining unit 2901. The determination unit 2902 determines a message (notification information) corresponding to the first information and the second information obtained by the obtaining unit 2901, from the message data 610 stored in advance in the HDD 205. The message data 610 is the same as that in the first embodiment, and as illustrated in FIG. 7, the remote operation state 701 that is the first information, the device login status 702 that is the second information, and the message 703 expressing the progress status of the remote connection are stored in the message data 610 in association with one another. The determination unit 2902 transmits the determined notification information to the web browser 502 of the PC 101A.

In the case where the notification unit 603 receives the notification information (message) determined by the determination unit 2902 of the image forming apparatus 102A, the notification unit 603 notifies the user of the PC 101A of the notification information. The notification is performed such that the web browser 502 displays the notification information (message) in the display device 406 of the PC 101A in a browsable manner. Timings of the determination of the notification information in the determination unit 2902 and the notification in the notification unit 603 are the same as those in the first embodiment. Specifically, the determination unit 2902 first determines the message to be displayed depending on the login status, and causes the message to be displayed before reception of the start instruction of the remote operation. For example, at a stage where the “remote operation” menu is selected on the remote UI screen, the determination unit 2902 determines the message to be displayed, and transmits the message to the PC 101A together with the screen data of the remote operation screen. The notification unit 603 displays the remote operation screen based on the received screen data, and displays the message determined by the determination unit 2902. Since the start instruction of the remote operation is not inputted at this stage, the remote operation state (first information) is “before start”. In the case where the device login status at this stage is “login user absent”, the message “remote operation can be started” is displayed. In the case where the device login status is “login user present”, the message “remote operation can be started. Currently, another user is using device. Process will wait for use permission from user using device in case where remote operation is started” is displayed.

Moreover, in the case where at least one of the first information and the second information is changed, the determination unit 2902 updates the notification information, and transmits the notification information to the PC 101A. Specifically, in the case where the VNC server 320 receives the start instruction of the remote operation from the PC 101A, the determination unit 2902 updates the notification information based on the login status and the information indicating permission or non-permission of the remote operation, and transmits the notification information to the PC 101A. The notification unit 603 receives the updated notification information, and displays the notification information on the remote operation screen. Moreover, in the case where the state where the remote operation is executable is established, the determination unit 2902 updates the notification information based on the login status, and transmits the notification information to the PC 101A. The notification unit 603 receives the updated notification information, and displays the notification information on the remote operation screen.

Note that the information indicating permission or non-permission of the remote operation is determined by making an inquiry to the user of the image forming apparatus 102A as in the first embodiment. In the case where an answer to the inquiry (confirmation screen 1800) by the user indicates permission of the remote connection or the case where the answer to the inquiry indicates permission of the remote connection with the operation of the user continued, the connection processing component 321 sends back “connection permitted”. In the case where the answer to the inquiry indicates denial of the remote operation, the connection processing component 321 sends back “connection denied”. The connection processing component 321 (VNC server 320) transmits the determined response to the obtaining unit 2901.

Moreover, the authentication component 311 determines whether to continue the login of the user or to perform logout depending on the answer to the inquiry. As in the first embodiment, in the case where the answer to the inquiry indicates permission of the remote operation, the authentication component 311 performs the logout of the user. In the case where the answer to the inquiry indicates denial of the remote operation and the case where the answer to the inquiry indicates permission of the remote connection by the remote user with the operation of the user continued, the authentication component 311 maintains the login state of the user. In the case where the login status (login user present/login user absent) changes, the authentication component 311 transmits the login status to the obtaining unit 2901.

In the case where the user using (logging into) the image forming apparatus 102A is absent at the moment of reception of the start instruction of the remote operation, the connection processing component 321 does not perform the above-mentioned inquiry. The connection processing component 321 transmits a response to the effect that the remote operation is permitted, to the obtaining unit 2901 and the PC 101A.

In the case where the obtaining unit 2901 receives the start instruction of the remote operation from the remote operation request transmission unit 604, the obtaining unit 2901 changes the remote operation state to “preparation ongoing”, and stores the remote operation state in the RAM 203. Moreover, in the case where the obtaining unit 2901 obtains the response to the start instruction of the remote operation from the connection processing component 321, the obtaining unit 2901 determines the remote operation state (first information). In the case where the response of permitting the remote operation is obtained, the obtaining unit 2901 changes the remote operation state to “ongoing”, and stores the remote operation state in the RAM 203. In the case where the response of denying the remote operation is received, the obtaining unit 2901 changes the remote operation state back to “before start”, and stores the remote operation state in the RAM 203. Note that, before the reception of the start instruction of the remote operation from the remote operation request transmission unit 604, the obtaining unit 2901 stores “before start” as the remote operation state in the RAM 203.

Moreover, in the case where the login process or processes such as the logout is performed in the authentication component 311 and the login status changes, the image forming apparatus 102A transmits the information indicating the login status to the PC 101A.

In the second embodiment, message examples and screen examples displayed in the PC 101A are the same as those in the first embodiment. Specifically, in the case where the remote operation state is “before start” and the use status (device login status) of the image forming apparatus 102A is “login user absent”, the first remote operation screen 1300 illustrated in FIG. 13 is displayed in the PC 101A. In the case where the remote operation state is “before start” and the use status (device login status) of the image forming apparatus 102A is “login user present”, the second remote operation screen 1400 illustrated in FIG. 14 is displayed in the PC 101A.

In the case where the remote operation state is “preparation ongoing” and the use status (device login status) of the image forming apparatus 102A is “login user absent”, the third remote operation screen 1600 illustrated in FIG. 16 is displayed in the PC 101A. In the case where the remote operation state is “preparation ongoing” and the use status (device login status) of the image forming apparatus 102A is “login user present”, the fourth remote operation screen 1700 illustrated in FIG. 17 is displayed in the PC 101A.

In the case where the remote operation state is “ongoing” and the use status (device login status) of the image forming apparatus 102A is “login user absent”, the fifth remote operation screen 1900 illustrated in FIG. 19 is displayed in the PC 101A. In the case where the remote operation state is “ongoing” and the use status (device login status) of the image forming apparatus 102A is “login user present”, the sixth remote operation screen 2000 illustrated in FIG. 20 is displayed in the PC 101A.

In the case where the user of the image forming apparatus 102A denies the remote operation, the error screen 2100 illustrated in FIG. 21 is displayed in the PC 101A.

As explained above, in the information processing system 100A of the second embodiment, it is possible to determine the contents of the message expressing the progress status of the remote connection on the image forming apparatus 102A side and display the message in the PC 101A. As in the first embodiment, the contents of the message are determined depending on the remote operation state 701 and the use status of the image forming apparatus 102A (device login status 702). This allows the remote user to check not only the remote operation state but also whether another user is using the image forming apparatus 102A or not in the case where the remote user checks the progress status of the remote connection on the screen of the PC 101A. In a conventional technique, the remote user operates the image forming apparatus 102A while being unable to grasp the use status of the image forming apparatus 102A by another user. In the present embodiment, since various messages are displayed on the PC 101A side depending on the use status such as whether the image forming apparatus 102A is used by another user or not, the use status of the image forming apparatus 102A at a remote location is visualized. Accordingly, the remote user can grasp the progress status of the remote connection in further detail. The operability of the remote operation is thereby improved.

Although the preferred embodiments of the present disclosure are explained above with reference to the attached drawings, the present disclosure is not limited to these examples. For example, the above-mentioned modified examples may be applied to the configuration of the second embodiment. Moreover, the processing procedure illustrated in each flowchart, the display contents of each screen, and the texts of the messages expressing the progress status of the remote connection are examples for explaining the present disclosure. It is apparent that those skilled in the art can come up with various change examples and modified examples within the scope of the disclosed technical spirit, and it is understood that these change examples and modified examples also belong to the technical scope of the present disclosure as a matter of course.

The information processing apparatus of the present disclosure can improve operability in the remote operation of the image forming apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-188439, filed Oct. 25, 2024, which is hereby incorporated by reference herein in its entirety.

What is claimed is:

1. An information processing apparatus capable of performing a remote operation of an image forming apparatus, the information processing apparatus comprising:
one or more processors; and
one or more memories storing instructions to cause the one or more processors to function as:
a notification unit configured to give notification of notification information on a progress status of remote connection, wherein
the notification information is determined based on first information indicating a state of the remote operation between the information processing apparatus and the image forming apparatus and second information indicating a use status of the image forming apparatus.

2. The information processing apparatus according to claim 1, wherein the instructions further cause the one or more processors to function as:
an obtaining unit configured to obtain the first information and the second information; and
a determination unit configured to determine the notification information based on the first information and the second information obtained by the obtaining unit.

3. The information processing apparatus according to claim 1, wherein the instructions further cause the one or more processors to function as a reception unit configured to receive the notification information determined by the image forming apparatus, wherein
the notification unit gives the notification of the notification information received by the reception unit.

4. The information processing apparatus according to claim 1, wherein the notification unit gives the notification of the notification information before execution of an operation of a start instruction of the remote operation.

5. The information processing apparatus according to claim 4, wherein, in a case where at least one of the first information and the second information is changed, the notification unit further updates the notification information.

6. The information processing apparatus according to claim 5, wherein, in a case where the start instruction of the remote operation is transmitted to the image forming apparatus, the notification unit updates the notification information.

7. The information processing apparatus according to claim 5, wherein, in a case where a state where the remote operation is executable is established, the notification unit updates the notification information.

8. The information processing apparatus according to claim 1, wherein the first information is determined based on whether a start instruction of the remote operation is transmitted from the information processing apparatus to the image forming apparatus or not or a response to the start instruction from the image forming apparatus.

9. The information processing apparatus according to claim 1, wherein the state of the remote operation indicated by the first information includes at least one of
a first state being a state before execution of an operation of a start instruction of the remote operation in the information processing apparatus or a state after reception of a response to the effect that the remote operation is not permitted from the image forming apparatus,
a second state being a state after transmission of the start instruction of the remote operation to the image forming apparatus by the information processing apparatus and before reception of a response indicating permission or non-permission of the remote operation from the image forming apparatus, and
a third state being a state where the remote operation is executable as a result of the start instruction and the response.

10. The information processing apparatus according to claim 9, wherein, in a case where the state of the remote operation indicated by the first information is the first state or the second state and the second information is information indicating that the image forming apparatus is used, the notification information further includes information of standby for use permission from a user logged in the image forming apparatus.

11. The information processing apparatus according to claim 9, wherein, in a case where the state of the remote operation indicated by the first information is the third state and the second information indicates that the image forming apparatus is used, the notification information further includes information indicating that an operation screen of the image forming apparatus is shared with a user logged in the image forming apparatus.

12. The information processing apparatus according to claim 1, wherein the notification unit displays the notification information by using a web browser such that the notification information is browsable.

13. The information processing apparatus according to claim 1, wherein a remote framebuffer (RFB) protocol is used for the remote connection between the image forming apparatus and the information processing apparatus.

14. An information processing method executed by an information processing apparatus capable of performing a remote operation of an image forming apparatus, the information processing method comprising:
giving notification of notification information on a progress status of remote connection, wherein
the notification information is determined based on first information indicating a state of the remote operation between the information processing apparatus and the image forming apparatus and second information indicating a use status of the image forming apparatus.

15. A non-transitory computer-readable storage medium storing a program which causes a computer to execute an information processing method, the computer capable of performing a remote operation of an image forming apparatus, the information processing method comprising:
giving notification of notification information on a progress status of remote connection, wherein
the notification information is determined based on first information indicating a state of the remote operation between the information processing apparatus and the image forming apparatus and second information indicating a use status of the image forming apparatus.
